(19) United States
(12) Patent Application Publication
(10) Pub. No.: US 2026/0056784 A1
(43) Pub. Date: Feb. 26, 2026

(54) RESOURCE SHARING FOR CONTENT DELIVERY SYSTEMS AND APPLICATIONS

(71) Applicant: NVIDIA Corporation, Santa Clara, CA (US)

(72) Inventors: Shih-Hsin Li, San Jose, CA (US); Jeffrey Alan Bolz, Cedar Park, TX (US); Samuel Reed Koser, Santa Clara, CA (US); Eric Sovelen Werness, San Jose, CA (US); James Jones, San Diego, CA (US); Andy Chih Yung King, San Jose, CA (US)

(21) Appl. No.: 18/810,897

(22) Filed: Aug. 21, 2024

(51) Int. Cl. G06F 9/50

(52) U.S. Cl. CPC G06F 9/5016

(57) ABSTRACT

In various examples, static resources—or physical memory locations storing the static resources—may be shared between instances of an application(s) running in a distributed environment. For instance, the disclosed systems and methods may determine whether application resources are shareable (e.g., static or dynamic) by evaluating metadata associated with the resources. In some examples, the systems may allocate a portion (e.g., a range) of a virtual memory associated with an instance of the application for use as a binding target for a static resource. The portion of the virtual memory may then be mapped to a physical memory allocation storing the static resource. In this way, multiple virtual memory portions for multiple instances of the application may be mapped to a same physical memory allocation, and the static resource may be shared between the different application instances.

### BACKGROUND

Various technologies may enable sharing of certain resources stored in memory between multiple application instances running on a same server or group of servers. For instance, some of these technologies may help some applications—such as gaming applications or other interactive applications—using graphics application programming interfaces (APIs) achieve higher density. However, while these technologies may be applied and used for some graphics APIs, applying the same or similar techniques to other graphics APIs, such as modern and/or low-level graphics APIs, has proven to be challenging.

For instance, in some graphics APIs (e.g., legacy graphics APIs), a system driver may be used to manage associations between memory and application resources (e.g., textures, buffers, render targets, neural network or model weights, etc.). However, in other graphics APIs (e.g., modern graphics APIs), the applications themselves may have control over these associations between the memory and the resources. As a result, the memory that could potentially be shared between application instances may be effectively rendered nonexistent. Additionally, in graphics API systems where resources may be managed and populated by the applications themselves, system drivers may not have access to resource content in order to determine whether multiple instances of the same resources are stored in memory.

### SUMMARY

Embodiments of the present disclosure relate to resource sharing for content delivery systems and applications. Systems and methods are disclosed that enable the sharing of certain resources between different instances of an application(s) running in a distributed environment—such as multiple instances of a gaming application or any other application running on a server or a group of servers.

For instance, the systems and methods of the present disclosure may determine whether application resources are shareable (e.g., static or dynamic) by evaluating supplemental information (e.g., metadata) associated with the resources. In some examples, the systems may allocate a portion (e.g., a range, a region, etc.) of a virtual memory associated with an instance of the application for use as a binding target for a static resource. The portion of the virtual memory may be mapped to a physical memory allocation storing the static resource. In this way, multiple virtual memory portions for multiple instances of the application may be mapped to a same physical memory location(s), and the static resource may be shared between the different application instances. Additionally, the systems and methods of the present disclosure may use graphics processing units (GPUs) to compute identifiers (e.g., hash values) corresponding to the shareable resources. The identifiers may be used to search for duplicates of the shareable resources for which physical memory is already allocated. In this way, duplicates of the shareable resources may be identified and consolidated and redundant portions of physical memory may be released.

In contrast to conventional systems, the systems of the present disclosure, in some embodiments, are able to transparently share resources in multi-application environments in which graphics APIs are used to control memory allocation, resource creation, and resource binding. For instance, by examining properties in metadata used to create an application resource, the systems of the present disclosure are able to identify which application resources can be shared and allocate virtual memory for those shareable application resources accordingly. Additionally, in contrast to conventional systems, the systems of the present disclosure are able to map virtual memory allocations for the shareable resources to dedicated, physical memory locations storing the application resources. Since the systems may allocate dedicated, physical memory for storing the application resources, instead of sharing memory that has multiple resources bound to it, the systems of the present disclosure may share physical memory having one resource binding between multiple application instances.

Additionally, in contrast to conventional systems, the systems of the present disclosure, in some embodiments, may compute resource identifiers using graphics processing units (GPUs). In this way, the systems of the present disclosure may be able to use the identifiers to identify duplicate, shareable resources in multi-application environments in which graphics APIs are used to control memory allocation, resource creation, and resource binding. By identifying shareable resources that have been duplicated or otherwise stored multiple times in multiple locations of a physical memory, the systems are able to consolidate the instances of the shareable resources into a single instance (or fewer instances) stored in a single location(s) of the physical memory, as well as to release portions of the physical memory previously used to store the duplicative resources. This promotes better memory utilization and allows systems to achieve greater density and host more application instances per device/system by sharing resources and reducing, or even eliminating, redundant copies of resources that may not be necessary.

### BRIEF DESCRIPTION OF THE DRAWINGS

The present systems and methods for resource sharing for content delivery systems and applications are described in detail below with reference to the attached drawing figures, wherein:

FIG. 1 is a data flow diagram illustrating an example of a process for resource sharing for content delivery systems and applications, in accordance with some embodiments of the present disclosure;

FIG. 2 illustrates an example of determining a classification associated with a resource, in accordance with some embodiments of the present disclosure;

FIG. 3 illustrates an example of determining a type of memory to allocate for an application resource, in accordance with some embodiments of the present disclosure;

FIG. 4 illustrates an example of determining a binding procedure for binding a resource to memory, in accordance with some embodiments of the present disclosure;

FIG. 5 illustrates an example of consolidating a duplicative resource, in accordance with some embodiments of the present disclosure;

FIG. 6A illustrates a hierarchical view of sharable resources and their corresponding physical and virtual memory allocations, in accordance with some embodiments of the present disclosure;

FIG. 6B illustrates a hierarchical view of an example of memory aliasing, in accordance with some embodiments of the present disclosure;

FIG. 7 is a flow diagram illustrating an example method that may be performed in association with sharing resources in multi-application environments that use graphics APIs to control memory allocation, resource creation, and/or resource binding, in accordance with some embodiments of the present disclosure;

FIG. 8 is a flow diagram illustrating an example method for remapping virtual memory from a first physical memory allocation to a second physical memory allocation, in accordance with some embodiments of the present disclosure;

FIG. 9 is a flow diagram illustrating an example method for consolidating duplicative resources and releasing physical memory allocations, in accordance with some embodiments of the present disclosure;

FIG. 10 illustrates an example parallel processing unit suitable for use in implementing at least some embodiments of the present disclosure;

FIG. 11A illustrates an example general processing cluster within the parallel processing unit of FIG. 10 suitable for use in implementing at least some embodiments of the present disclosure;

FIG. 11B illustrates an example memory partition unit of the parallel processing unit of FIG. 10 suitable for use in implementing at least some embodiments of the present disclosure;

FIG. 12A illustrates an example of the streaming multi-processor of FIG. 11A suitable for use in implementing at least some embodiments of the present disclosure;

FIG. 12B is an example conceptual diagram of a processing system implemented using the PPU of FIG. 10 suitable for use in implementing at least some embodiments of the present disclosure;

FIG. 12C illustrates an example system in which the various architecture and/or functionality of the various embodiments may be implemented;

FIG. 13 illustrates an example ray tracing pipeline suitable for use in implementing at least some embodiments of the present disclosure;

FIG. 14 illustrates an example acceleration structure suitable for use in implementing at least some embodiments of the present disclosure;

FIG. 15 illustrates an example shader record suitable for use in implementing at least some embodiments of the present disclosure;

FIG. 16 is a block diagram of an example computing device suitable for use in implementing some embodiments of the present disclosure; and

FIG. 17 is a block diagram of an example data center suitable for use in implementing some embodiments of the present disclosure.

### DETAILED DESCRIPTION

Systems and methods are disclosed related to resource sharing for content delivery systems and applications. For instance, to share memory and/or resources—such as textures, shader code, mesh data, machine learning model weights, or any other application resources—a system(s) may determine whether resources created on behalf of an application instance are suitable for sharing. That is, the system(s) may determine whether an application resource is a shareable resource or a non-shareable resource. In some examples, shareable resources may include or otherwise correspond to static resources associated with an application, such as images, textures, shader code, mesh data, machine learning model weights, or any other static resources. On the other hand, non-shareable resources may include or correspond to dynamic resources associated with the application, such as a render target resource or any other dynamic resources.

As described herein, in some instances, the application may include a game or game streaming application, a video streaming application, a machine control application, a machine locomotion application, a machine driving application, a synthetic data generation application, a model training application, a perception application, an augmented reality application, a virtual reality application, a mixed reality application, a robotics application, a security and surveillance application, an autonomous or semi-autonomous machine application, a deep learning application, an environment simulation application, an application for performing a machine simulation, a data center processing application, a generative AI application, an application using (large) language models, a conversational AI application, a light transport simulation application (e.g., ray tracing, path tracing, etc.), a collaborative content creation application for 3D assets, a digital twin system application, a cloud computing application and/or another type of application or service.

In some examples, to determine whether an application resource is shareable or non-shareable, the system(s) may obtain metadata associated with the resource. For instance, the system(s) may determine if a resource can be potentially shared by examining properties in the metadata used to create the resource. In some instances, if the metadata includes any property that indicates the resource content may be dynamic, the resource may be identified as a non-sharable resource. As an example, a render target resource may be non-sharable since its content may be expected to change frequently. In some examples, the system(s) may evaluate the properties in the metadata to determine classifications associated with the resources, and the classifications may indicate whether the resources are shareable, static resources or non-shareable, dynamic resources.

As described herein, the system(s) may, in some instances, allocate portions of a virtual memory to be bound to the shareable resources. The virtual memory may serve as a binding target specifically for the sharable resources, and, in some instances, all shareable resources may only be bound to the virtual memory. During memory allocation for application resources, the system(s) may determine whether to allocate virtual memory or physical memory. For instance, the application instance may submit a request to a memory allocation API to allocate memory for a resource. The system(s) may determine whether the request is for shareable memory or non-shareable memory. If the request is for non-shareable memory, the system(s) may allocate physical memory for the requested memory. However, if the request is for shareable memory, the system(s) may allocate virtual memory for the requested memory. In some examples, the system(s) may not allocate physical memory pages during allocation of the virtual memory.

In some examples, the system(s) may bind the application resources to memory resources. The system(s) may determine what classification or type of resources are being bound and perform a specific resource binding process/procedure depending on the resource classification. For instance, in the case of non-shareable/dynamic resources, the system(s) may bind the non-shareable resources to physical memory allocations. In the case of shareable/static resources, the system(s) may bind the shareable resources to the virtual memory allocations for those resources, and map the virtual memory allocations to physical memory allocations.

By way of example, and not limitation, after allocating virtual memory to be bound to the shareable resources, the system(s) may allocate dedicated, physical memory for storing the shareable resources. Once allocated, the system(s) may map the physical memory allocations for storing the shareable resources to the virtual memory allocations bound—or to be bound—to the shareable resources. In some examples, the system(s) may maintain a single physical memory allocation for a shareable resource, which may be mapped to multiple different virtual memory allocations bound to the shareable resource for different instances of the application. For instance, a first instance of the application may have a first virtual memory allocation for a shareable resource, a second instance of the application may have a second virtual memory allocation for the shareable resource, and so forth, and the first virtual memory allocation, the second virtual memory allocation, etc. may be mapped to a physical memory allocation storing the shareable resource.

In some examples, once the memory mapping is done between the virtual memory and the physical memory, the application instances may perform read and/or write operations to the virtual memory as usual. That is, the applications may start data transfer to/from the virtual memory since the virtual memory has physical memory pages mapped to it. Additionally, since the shareable resources have dedicated, physical memory allocations associated with them, sharing the resources is possible, and instead of sharing memory that has multiple resources bound to it, the system(s) may share the physical memory that only has one resource binding. Such dedicated allocations may work transparently to the application instances.

In some instances, the system(s) may determine that one or more portions of the physical memory have been allocated to store shareable resources that are duplicative of one another. That is, the system(s) may determine whether the same, shareable resource has been stored multiple times in the physical memory. Additionally, in such instances, the system(s) may perform one or more operations or procedures to consolidate the duplicative shareable resources to a single resource and single physical memory allocation.

For example, and for a shareable resource, the system(s) may compute an identifier corresponding to the shareable resource. The identifier may include a hash value corresponding to the shareable resource, and the system(s) may use one or more hashing algorithms to compute the hash identifier. In some instances, the identifier may be computed based on the content of the shareable resource. As an example, if the shareable resource is a 2D image corresponding to a texture associated with the application, the system(s) may compute the identifier based on the appearance of the 2D image. In this way, if the same 2D image is already stored in the physical memory, the identifier may be looked up (e.g., in a database, key-value store, etc.) and the system(s) may determine whether the shareable resource is a duplicate. The described method of computing a hash based on the content of the file is intended to serve as an illustrative example. Other methods of computing a hash are also contemplated, such as generating a hash from the file's metadata or using a combination of content and metadata, among other approaches.

In some examples, the system(s) may use one or more graphics processing units (GPUs) to compute the identifiers for the resources. As described above and herein, in systems where resources and memory are managed in the driver, identifiers may easily be computed from the resource content to identify copies of the same resource. However, in systems where resources are managed and populated by the application, the system driver may not have access to the resource content to generate hashes from the host (e.g., CPU). Thus, the system(s) of the present disclosure, in some instances, may compute the resource identifiers by moving the operation to the GPUs. In some examples, the computation of the identifiers using the GPUs may be performed after the application submits commands to the GPUs for transferring data to the shareable memory.

In some examples, the system(s) may use one or more databases to store associations between the resource identifiers and the physical memory allocations. For instance, and for an application resource that is stored in the physical memory, the system(s) may store, in the database(s), data indicating the identifier corresponding to the application resource and the portion (e.g., location, address, etc.) of the physical memory allocated to store the application resource. As such, to determine whether at least one instance of an application resource has been stored in the physical memory, the system(s) may query the database(s) using the application identifier for that resource. If the application identifier appears multiple times in the database(s) and/or multiple physical memory allocations are listed as being bound to the application resource corresponding to that application identifier, the system(s) may determine that multiple copies of the shareable resource exist.

As described herein, the system(s) of the present disclosure may consolidate multiple instances of duplicative shareable resources and/or their corresponding physical memory allocations. For instance, if the system(s) determine that multiple allocations of the physical memory have been reserved for the same shareable resource, the system(s) may migrate or otherwise remap all virtual memory allocations for the shareable resource to the same, physical memory allocation for the shareable resource. After the migration and/or remapping is complete, the system(s) may release the excess or redundant physical allocations for the copies of the shareable resource.

By way of example, and not limitation, a first instance of an application may submit a request to create a resource and allocate memory for storing the resource. Based on this request, the system(s) of the present disclosure may—using the techniques described herein—determine the requested resource is a shareable resource, allocate virtual memory to be bound to the shareable resource, and map the virtual memory allocation to a first portion of a physical memory allocated for storing the new shareable resource. After completing these operations, and as described in further detail herein, the system(s) may compute an identifier for the shareable resource and query the database(s) using the identifier to determine whether a second portion of the physical memory has already been allocated to store the shareable resource (e.g., a duplicate of the requested resource). If the system(s) determines, based on the query, that the new resource is in fact a duplicate of a previous resource already stored in the second portion of the physical memory, the system(s) may remap the virtual memory allocation associated with the first instance of the application from the first portion of the physical memory to the second portion of the physical memory, and release the first portion of the physical memory so that the first portion may be used/reused for storing other data.

In some examples, if the system(s) determines that a newly created/stored resource is not a duplicate, the system(s) may update the database(s) to indicate the portion of the physical memory allocated to store the resource. For instance, the system(s) may store, in the database(s), data indicating an association between the identifier corresponding to the resource and the portion of the physical memory that has been allocated and/or is storing the resource. In this way, the system(s) may later query the database(s) when new resources are created to determine whether the new resources are duplicates of other resources already stored in the physical memory.

In at least one embodiment, the system(s) may detect memory aliasing (e.g., API-level aliasing) and/or dynamic changes to physical memory content and, in response, refrain from sharing (or cease sharing) those memory resources. As described herein, if a resource(s) is already in a shared state and determined to be subject to memory aliasing, the system(s) of the present disclosure may bail the resource(s) out from sharing. Additionally, or alternatively, the system(s) may detect if already shared memory is written to and/or modified such that the contents stored in physical memory change. In such instances, the system(s) may stop sharing the resources, refrain from sharing the resources, or otherwise bail the resources out from sharing. In some instances, to stop sharing the resources, the system(s) may transparently transition the resource(s) to an instance-local allocation and copy the currently associated shared content into it.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, resource sharing between applications and/or services hosted on data center infrastructure, data center processing, conversational AI, light transport simulation (e.g., ray tracing, path tracing, etc.), collaborative content creation for 3D assets, cloud computing, generative AI, (large) language models, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for application resource sharing, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for performing generative AI operations, systems for performing operations using a large language model, and/or other types of systems.

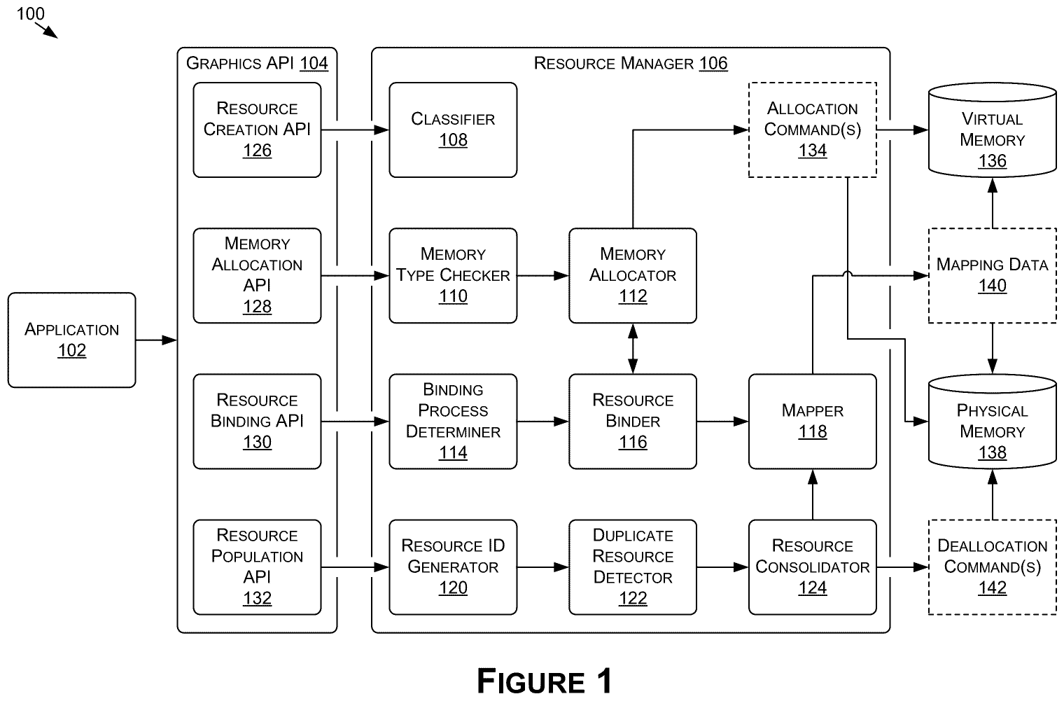

With reference to FIG. 1, FIG. 1 is a data flow diagram illustrating an example of a process 100 for resource sharing for content delivery systems and applications, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may be implemented using, amongst additional or alternative components, an application 102, a graphics application programming interface (API) 104, and a resource manager 106. The resource manager may include a classifier 108, a memory type checker 110, a memory allocator 112, a binding process determiner 114, a resource binder 116, a mapper 118, a resource identifier (ID) generator 120, a duplicate resource detector 122, and a resource consolidator 124. Additionally, the graphics API 104 may include a resource creation API 126, a memory allocation API 128, a resource binding API 130, and a resource population API 132.

As an overview, the process 100 may include the application 102 requesting creation of a resource using the resource creation API 126, and the classifier 108 of the resource manager 106 may determine a classification associated with the resource. The application 102 may also request allocation of memory for the resource using the memory allocation API 128. The memory type checker 110 may determine whether the requested memory is shareable or non-shareable memory, and the memory allocator 112 may an generate allocation command(s) 134 to allocate a portion(s) of a physical memory 138 if the requested memory is non-shareable and allocate a portion(s) of a virtual memory 136 if the requested memory is shareable. The application 102 may also request the resource be bound to the memory using the resource binding API 130. The binding process determiner 114 may determine a binding procedure to be used based on whether the resource/memory is a shareable resource/memory or a non-shareable resource/memory. The resource binder 116 may implement the selected binding procedure to bind the resource to the memory. In the case of virtual memory, the mapper 118 may generate mapping data 140 to map the virtual memory 136 allocations to physical memory 138 allocations storing the resource. The application 102 may also request population of the resource using the resource population API 132. The resource ID generator 120 may compute an identifier for the populated resource, and the duplicate resource detector 122 may use the identifier to determine whether a duplicate of the resource is already stored in the physical memory. If a duplicate exists, the resource consolidator 124 may consolidate the physical memory allocations/duplicate resource(s), and send a deallocation command(s) 142 to release one or more of the portion(s) of the physical memory 138 allocated for storing the resource(s), as well as causing the mapper 118 to update the mapping data 140.

In one or more embodiments, the application 102 may represent multiple application instances running on a virtual machine. The application 102 may include a game, a video streaming application, a machine control application, a machine locomotion application, a machine driving application, a synthetic data generation application, a model training application, a perception application, an augmented reality application, a virtual reality application, a mixed reality application, a robotics application, a security and surveillance application, an autonomous or semi-autonomous machine application, a deep learning application, an environment simulation application, a data center processing application, a generative AI application, an application using (large) language models, a conversational AI application, a light transport simulation application (e.g., ray tracing, path tracing, etc.), a collaborative content creation application for 3D assets, a digital twin system application, a cloud computing application and/or another type of application or service.

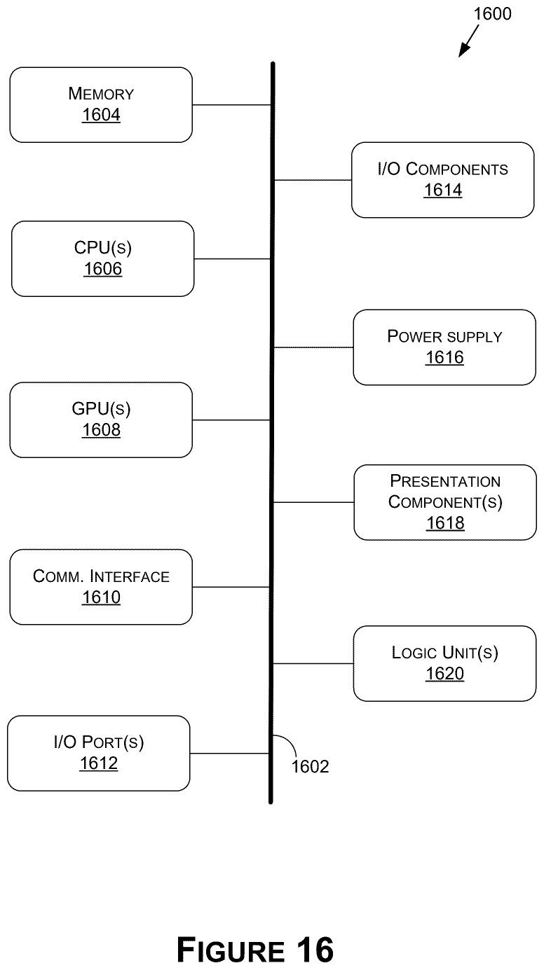

The application 102 may include a mobile application, a computer application, a console application, a tablet application, and/or another type of application. The application 102 may include instructions that, when executed by a processor(s) (e.g., the CPU(s) 1606 and/or the GPU(s) 1608 described in the example of FIG. 16), cause the processor(s) to, without limitation, configure, modify, update, transmit, process, and/or operate on the GPU state data, receive input data representative of user inputs to one or more input device(s), retrieve at least a portion of application data from memory, receive at least a portion of application data from a server(s), and/or cause display of data (e.g., image and/or video data) corresponding to the GPU state data on one or more displays. In one or more embodiments, the application 102 may operate as a facilitator for enabling interacting with and viewing output from an application instance hosted on an application server using a client device(s).

In some embodiments, the application 102 may be used to perform simulations within a simulation environment (e.g., NVIDIA's DriveSIM) using simulated data (e.g., simulated sensor data of simulated sensors of a virtual or simulated machine). These simulations may be used to test performance of algorithms, systems, and/or processes prior to deploying them in a real-world scenario(s). In some instances, the application 102 may be used to generate synthetic training data for optimizing one or more models (e.g., machine learning models, neural networks, etc.). In some embodiments, the application 102 may be a three-dimensional (3D) content collaboration application (e.g., NVIDIA's OMNIVERSE) for industrial digitalization, generative physical AI, and/or other use cases, applications, or services. For example, the content collaboration application or system may include a system for using or developing universal scene descriptor (USD) (e.g., OpenUSD) data for managing objects, features, scenes, etc. within a simulated environment, digital environment, etc. The application may include real physics simulation, such as using NVIDIA's PhysX SDK, in order to simulate real physics and physical interactions with simulations hosted by the application. The application may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In various examples, to share memory and/or resources—such as textures, shader code, mesh data, or any other application resources—the classifier 108 of the resource manager 106 may be configured to determine whether resources created on behalf of an instance of the application 102 are suitable for sharing. That is, the classifier 108 may determine whether a resource of the application 102 is a shareable resource or a non-shareable resource. In some examples, shareable resources may include or otherwise correspond to static resources associated with an application, such as images, textures, shader code, mesh data, or any other static resources. On the other hand, non-shareable resources may include or correspond to dynamic resources associated with the application, such as a render target resource or any other dynamic resources. As such, the classifier 108 may determine whether a resource is a static resource or a dynamic resource.

In some examples, to determine whether a resource is shareable or non-shareable, the classifier 108 may obtain metadata associated with the resource. For instance, the classifier 108 may determine if a resource can be potentially shared by examining properties in the metadata used by the resource creation API 126 to create the resource. In some instances, if the metadata includes any property that indicates the resource content may be dynamic, the resource may be identified by the classifier 108 as a non-sharable resource. As an example, a render target resource may be non-sharable since its content may be expected to change frequently. In some examples, the classifier 108 may evaluate the properties in the metadata to determine classifications associated with the resources, and the classifications may indicate whether the resources are shareable, static resources or non-shareable, dynamic resources.

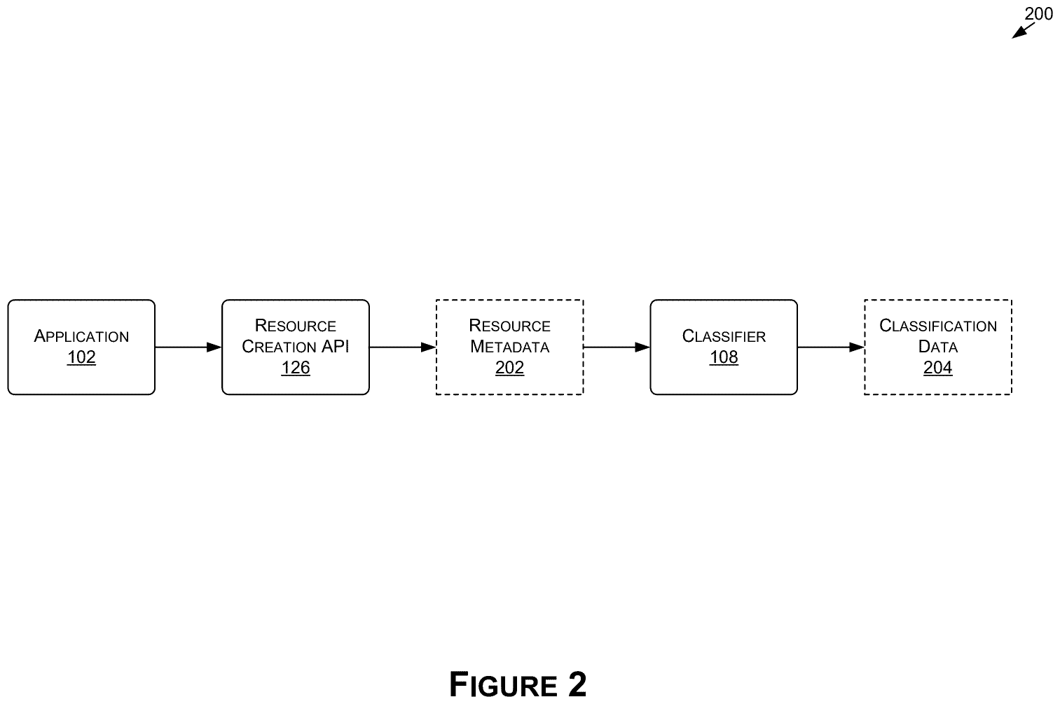

For instance, FIG. 2 illustrates an example process 200 of determining a classification associated with a resource, in accordance with some embodiments of the present disclosure. As shown, the application 102—which may represent an instance of the application 102 that is running on a server or a group of servers—may invoke the resource creation API 126 to create the resource. The classifier 108 may obtain resource metadata 202 associated with the creation of the resource. The classifier 108 may, in some examples, evaluate the properties included in the resource metadata 202 to determine whether the created resource is shareable (e.g., static) or non-shareable (e.g., dynamic). For instance, if the resource metadata 202 includes one or more properties (e.g., more than a threshold number of properties) indicating the resource content may be dynamic, the resource may be identified by the classifier 108 as a non-sharable resource. As an example, if the resource metadata 202 includes properties commonly associated with textures (e.g., size, format, type, etc.), the classifier 108 may determine the resource is a shareable resource. In some examples, the classifier 108 may generate classification data 204 associated with the resource. The classification data 204 may indicate the classification of the resource, a confidence level associated with the classification (e.g., a confidence of whether the resource is shareable or non-shareable), or any other information associated with the resource. In some examples, the classification data may be used by the memory type checker 110 and/or the memory allocator 112 when determining what type of memory to allocate for the resource, as described in further detail herein.

Referring back to the example of FIG. 1, the process 100 may include the application 102 requesting allocation of memory for storing the resource. For instance, the application 102 may submit a request to the memory allocation API 128 of the graphics API 104 to allocate memory for the resource. In some examples, the memory type checker 110 may determine the type of memory to be allocated. For instance, the memory type checker 110 may determine whether physical memory or virtual memory is to be allocated for the resource. In some instance, the memory type checker 110 may determine the type of memory to be allocated based on the classification of the resource determined by the classifier 108 and/or based on the requested type of memory requested by the application 102. For instance, the application 102 may request shareable or non-shareable memory be allocated for the resource. Additionally, or alternatively, the classification data 204 may indicate whether the resource is shareable or non-shareable, and the memory type checker 110 may determine whether to allocate only physical memory or to allocate virtual memory based on the classification of the resource.

The memory allocator 112 may submit the allocation command(s) 134 to allocate portions of the type(s) of memory based on the memory type checker 110 determining whether physical memory 138 or virtual memory 136 is to be allocated. As described herein, the memory allocator 112 of the resource manager 106 may, in some instances, initially allocate portions of the virtual memory 136 to be bound to the shareable resources. The virtual memory 136 may serve as a binding target specifically for the sharable resources, and, in some instances, all shareable resources may only be bound to the virtual memory 136. That is, if the request is for non-shareable memory, the memory allocator 112 may submit the allocation command(s) 134 to the physical memory 138 to allocate a portion(s) of the physical memory 138. However, if the request is for shareable memory, the memory allocator 112 may submit the allocation command(s) 134 to the virtual memory 136 to allocate a portion(s) of the virtual memory 136.

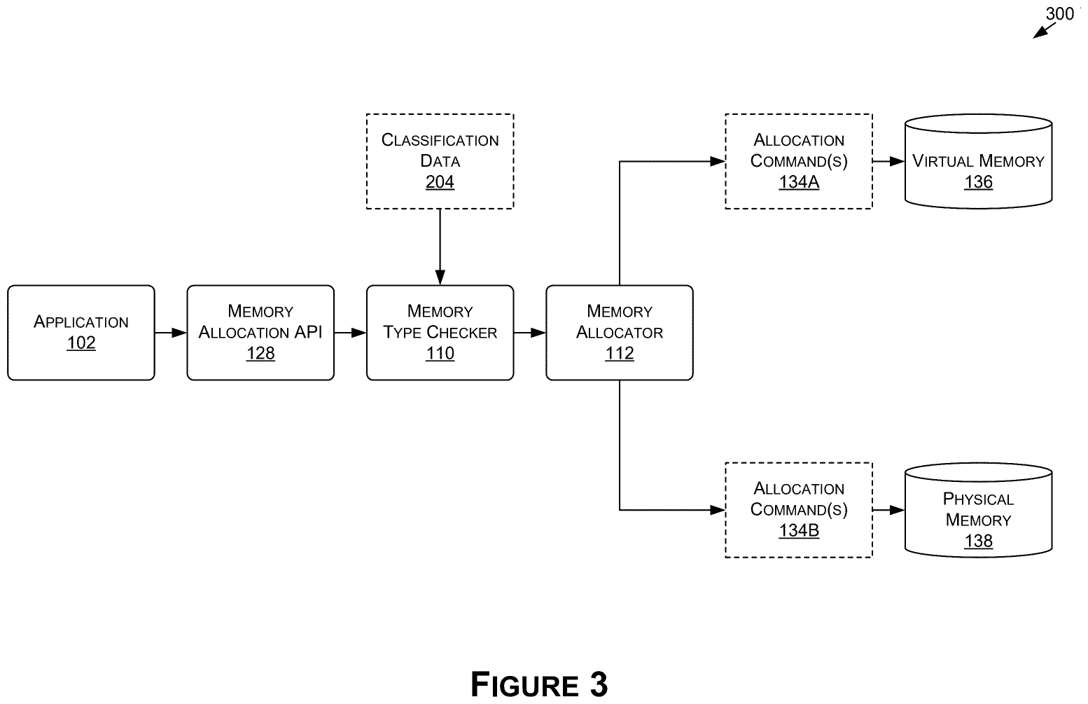

For instance, FIG. 3 illustrates an example process 300 for determining a type of memory to allocate for an application resource, in accordance with some embodiments of the present disclosure. The process 300 may include the application 102 using the memory allocation API to request the memory. The memory type checker 110 may determine the type of memory to be allocated based on the type of memory requested by the application 102. Additionally, or alternatively, the memory type checker 110 may determine the type of memory to be allocated based at least on the classification data 204. If the memory allocator 112 determines that shareable memory is to be allocated, the memory allocator 112 may submit the allocation command(s) 134A to the virtual memory 136 to allocate the portion(s) of the virtual memory 136. However, if the memory allocator 112 determines that non-shareable memory is to be allocated, the memory allocator 112 may submit the allocation command(s) 134B to the physical memory 138 to allocate the portion(s) of the physical memory 138 Referring back to the example of FIG. 1, the process 100 may include the application 102 using the resource binding API 130 to bind the created resources to the allocated memory. In some examples, the binding process determiner 114 may determine what classification or type of resources are being bound, and cause the resource binder 116 to perform a specific resource binding process/procedure depending on the resource classification/memory type. For instance, if the binding process determiner 114 determines that the resources to be bound include non-shareable/dynamic resources, the resource binder 116 may perform a conventional resource binding process to bind the non-shareable resources to allocations of the physical memory 138. In contrast, if the binding process determiner 114 determines that the resources to be bound include shareable/static resources, the resource binder 116 may bind the newly created shareable resources to allocations of the virtual memory 136 for those resources. Then, and in the case of shareable resources, the mapper 118 may generate the mapping data 140 to map the allocations of the virtual memory 136 to allocations of the physical memory 138.

By way of example, and not limitation, after allocating the portion(s) of the virtual memory 136 to be bound to the shareable resources, the memory allocator 112 may also allocate dedicated, physical memory 138 for storing the shareable resources. Once allocated, the mapper 118 may map the physical memory 138 allocations for storing the shareable resources to the virtual memory 136 allocations bound—or to be bound—to the shareable resources. In some examples, the resource manager 106 may maintain a single, physical memory 138 allocation for a shareable resource, which may be mapped to multiple different virtual memory 136 allocations bound to the shareable resource for different instances of the application 102. For instance, a first instance of the application 102 may have a first virtual memory 136 with allocations for a shareable resource, a second instance of the application 102 may have a second virtual memory 136 with allocations for the shareable resource, and so forth, and the allocations of the first virtual memory 136, the allocations of the second virtual memory 136, etc. may be mapped to an allocation of the physical memory 138 for storing the shareable resource.

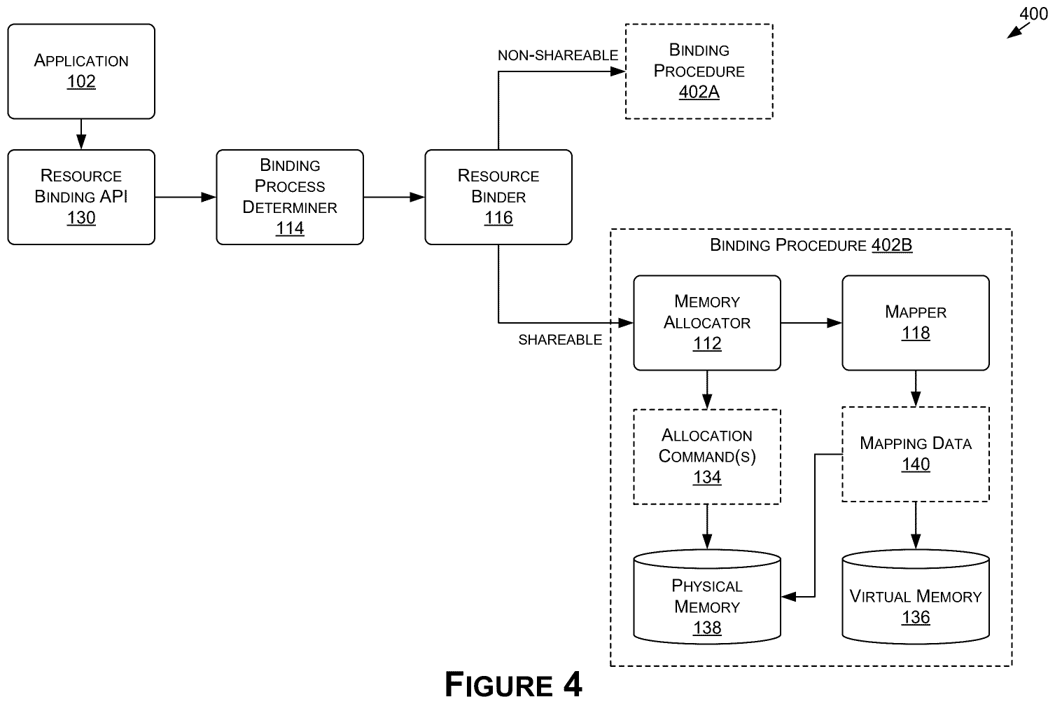

For instance, FIG. 4 illustrates an example of a process 400 for determining a binding procedure for binding a resource to memory, in accordance with some embodiments of the present disclosure. As shown, the application 102 may invoke the resource binding API 130 to bind the resource to the memory, and the binding process determiner 114 may determine whether a first binding procedure 402A or a second binding procedure 402B should be used to bind the resource to the memory. For instance, the binding process determiner 114 may determine whether the resource that is to be bound is shareable or non-shareable based on the classification data 204, based on the requested memory for the resource (e.g., whether shareable or non-shareable memory was requested), based on the allocated memory for the resource (e.g., whether physical memory 138 or virtual memory 136 was allocated for the resource), etc. If the binding process determiner 114 determines the resource to be bound is non-shareable, the resource binder 116 may perform the first binding procedure 402A, which may be a conventional binding procedure to bind a resource to physical memory. However, if the binding process determiner 114 determines the resource to be bound is shareable, the resource binder 116 may perform the second binding procedure 402B.

As part of the second binding procedure 402B, the memory allocator 112 may submit the allocation command(s) 134 to allocate one or more portions of the physical memory 138 for storing the shareable resource. For instance, as described above, the memory allocator 112 may initially allocate the portion(s) of the virtual memory 136 for binding to the shareable resource, so in the second binding procedure 402B the memory allocator 112 may allocate the portion(s) of the physical memory 138 for actually storing the shareable resource. Then, the mapper 118 may generate the mapping data 140 and map the allocated portion(s) of the virtual memory 136 to the portion(s) of the physical memory 138.

In some examples, once the memory mapping is done between the virtual memory 136 and the physical memory 138, the application 102 may perform read and/or write operations to the virtual memory 136 as usual. That is, the application 102 may start data transfer to/from the virtual memory 136 since the virtual memory 136 has one or more pages of the physical memory 138 mapped to it. Additionally, since the shareable resource has dedicated, physical memory allocations associated with it, sharing the resource is possible, and instead of sharing physical memory 138 that has multiple resources bound to it, the system(s) of the present disclosure may share the physical memory 138 that only has one resource binding.

Referring back to the example of FIG. 1, in some instances, the resource manager 106 may determine that one or more portions of the physical memory 138 have been allocated to store shareable resources that are duplicative of one another. That is, the resource manager 106 may determine whether the same, shareable resource has been stored multiple times in the physical memory 138. Additionally, in such instances, the resource manager 106 may perform one or more operations or procedures to consolidate the duplicative shareable resources to a single resource and single physical memory allocation.

For example, and for a shareable resource, the resource ID generator 120 may compute an identifier corresponding to the shareable resource. The identifier may include a hash value corresponding to the shareable resource, and the resource ID generator 120 may use one or more hashing algorithms to compute the hash identifier. In some instances, the identifier may be computed based on the content of the shareable resource. As an example, if the shareable resource is a 2D image corresponding to a texture associated with the application, the resource ID generator 120 may compute the identifier based on the appearance of the 2D image. In this way, if the same 2D image is already stored in the physical memory 138, the identifier may be used by the duplicate resource detector 122 to query the physical memory 138 and/or a database for the identifier to determine whether the shareable resource is a duplicate.

In some examples, one or more graphics processing units (GPUs) may be used to compute the identifiers for the resources. As described above and herein, in systems where resources and memory are managed in the driver, identifiers may easily be computed from the resource content to identify copies of the same resource. However, in systems where resources are managed and populated by the application 102, the system driver may not have access to the resource content to generate hashes from the host (e.g., CPU). Thus, the resource manager 106 may compute the resource identifiers by moving the operation to the GPUs. In some examples, the computation of the identifiers using the GPUs may be performed after the application submits resource population commands to the GPUs for transferring data to the shareable memory.

As described herein, the resource consolidator 124 may consolidate multiple instances of duplicative shareable resources and/or their corresponding physical memory allocations. For instance, if the duplicate resource detector 122 determines that multiple allocations of the physical memory 138 have been reserved for the same shareable resource, the resource consolidator 124 may initiate a migration or otherwise cause a remapping of all virtual memory allocations for the shareable resource to the same, physical memory allocation for the shareable resource. After the migration and/or remapping is complete, the resource consolidator 124 may submit a deallocation command(s) 142 to cause the physical memory 138 to release the excess or redundant physical allocations for the copies of the shareable resource.

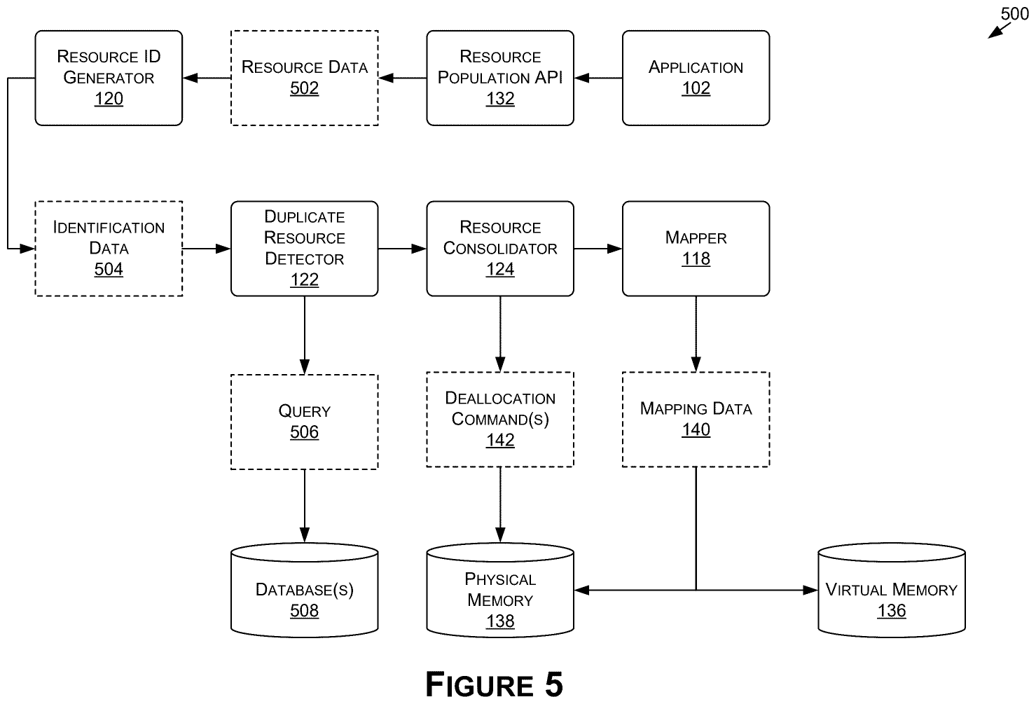

For instance, FIG. 5 illustrates an example of a process 500 for consolidating a duplicative resource, in accordance with some embodiments of the present disclosure. As shown in the example of FIG. 5, the application 102 may use the resource population API 132 to populate a newly created shareable resource. The resource ID generator 120 may evaluate resource data 502 corresponding to the resource, and compute identification data 504 associated with the resource. For instance, if the resource is an image corresponding to a texture, the resource ID generator 120—which may correspond to or be executed using a graphics processing unit—may use a hashing algorithm to compute a hash identifier for the image. This may include, in some examples, reading the resource file, converting the resource into a format suitable for hashing, and feeding this data into the hashing algorithm.

The duplicate resource detector 122 may use the identification data 504 to query 506 one or more databases 508 for the identifier. For instance, the database(s) 508 may store associations between the resource identifier (e.g., hash value) and locations or portions of the physical memory 138 allocated to storing the resource corresponding to that identifier. If a result of the query 506 is that the identifier is not in the database(s) 508, the identifier may be added to the database(s) 508 and associated with its physical memory allocation(s) so that duplicates of the resource can be avoided. On the other hand, if the result of the query 506 is that the identifier is included in the database(s) 508, the resource consolidator 124 may initiate consolidating the resource/memory. In some examples, the duplicate resource detector 122 may query the physical memory 138, as opposed to querying the database(s) 508.

To consolidate the resource/memory, the resource consolidator 124 may submit the deallocation command(s) 142 to the physical memory 138 indicating the portion(s) of the physical memory 138 that can be released and later reallocated to storing other resources that are non-duplicative. The mapper 118 may, in some examples, update the mapping data 140 to remap the allocation(s) of the virtual memory 136 to the single allocation(s) of the physical memory 138 storing the resource.

As noted above, if the duplicate resource detector 122 determines that the newly created/stored resource is not a duplicate, the process 500 may include updating the database(s) 508 to indicate the portion of the physical memory 138 allocated to store the resource (not shown). For instance, the duplicate resource detector 122 (and/or another component) may store, in the database(s) 508, data indicating an association between the identifier corresponding to the resource and the portion of the physical memory 138 that has been allocated and/or is storing the resource. In this way, the duplicate resource detector 122 may later query 506 the database(s) 508 when new resources are created to determine whether the new resources are duplicates of other resources already stored in the physical memory 138.

Referring back to the example of FIG. 1, in various instances, one or more of the components described in the example of FIG. 1 may include or be implement using one or more machine learning models. The machine learning model(s) may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

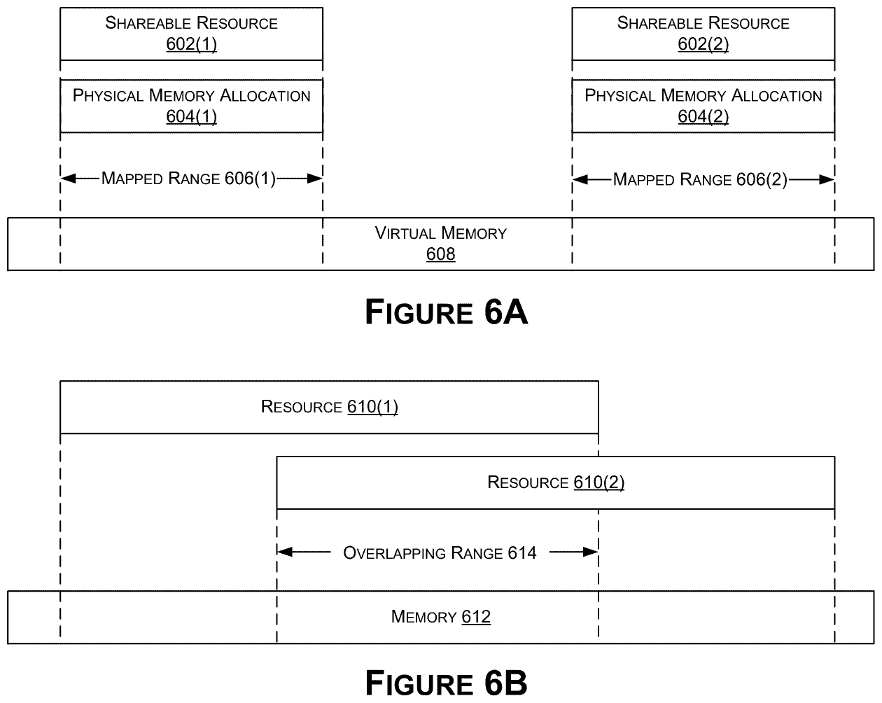

Referring now to FIG. 6A, FIG. 6A illustrates a hierarchical view of sharable resources and their corresponding physical and virtual memory allocations, in accordance with some embodiments of the present disclosure. For instance, a first shareable resource 602(1) may be stored using a first physical memory allocation 604(1), which has a first mapped range 606(1) to a first portion of a virtual memory 608. Similarly, a second shareable resource 602(1) may be stored using a second physical memory allocation 604(2), which has a second mapped range 606(2) to a second portion of the virtual memory 608. Additionally, although not shown, the first physical memory allocation 604(1) and the second physical memory allocation 604(2) may each be mapped to one or more other portions of one or more other virtual memories. For instance, the virtual memory 608 may be associated with a first instance of an application, such as the application 102, and the other virtual memory(ies) may be associated with one or more other instances of the application.

Referring now to FIG. 6B, FIG. 6B illustrates a hierarchical view of an example of memory aliasing, in accordance with some embodiments of the present disclosure. Memory aliasing may occur when a first resource 610(1) is mapped to a first portion of a memory 612 and shares an overlapping range 614 of the memory 612 with a second resource 610(2). That is, the first resource 610(1) is mapped to or stored using a first portion of the memory 612, and the second resource is mapped to or stored using a second portion of the memory 612, and the first portion of the memory 612 and the second portion of the memory 612 at least partially overlap one another. In such instances, memory aliasing occurs when an application binds multiple resources to the same or the “overlapping range” 614 of the memory 612. This may indicate that the application is likely to update the content of the resources 610 in the future, making them non-static resources. As such, these resources 610 may not be shareable. As described herein, if any resource(s) is already in a shared state and determined to be subject to memory aliasing, the system(s) of the present disclosure may bail the resource(s) out from sharing. The system driver may transparently transition the resource(s) to an instance-local allocation and copy the currently associated shared content into it.

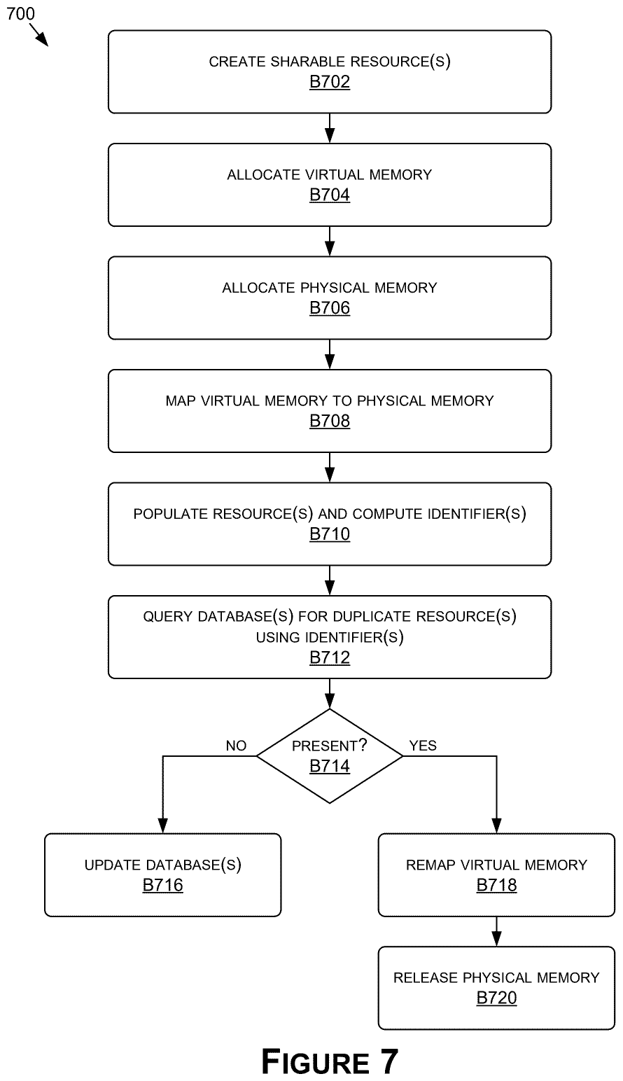

Now referring to FIGS. 7-9, each block of methods 700, 800, and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700, 800, and 900 are described, by way of example, with respect to the system of FIG. 1. However, these methods may additionally or alternatively be executed by any one system, or any combination of systems, including, but not limited to, those described herein.

FIG. 7 is a flow diagram illustrating an example method 700 that may be performed in association with sharing resources in multi-application environments that use graphics APIs to control memory allocation, resource creation, and/or resource binding, in accordance with some embodiments of the present disclosure. The method 700, at block B702, may include creating a shareable resource(s). For instance, the resource creation API 126 of the graphics API 104 may create the shareable resource(s) based at least on a request associated with an instance of the application 102. In some examples, the classifier 108 of the resource manager 106 may determine the created resource(s) is shareable based at least on evaluating properties included in metadata used to create the resource(s).

The method 700, at block B704, may include allocating virtual memory. For instance, the memory allocator 112 may allocate one or more portions of the virtual memory 136 for binding to the shareable resource(s). In some examples, the memory allocator 112 may allocate the virtual memory based at least on the memory type checker 110 determining that the application 102 requested that shareable-type memory be allocated. Additionally, or alternatively, the memory allocator 112 may allocate the virtual memory based at least on the classifier 108 determining a classification associated with the created resource. The classification may indicate the resource is a static resource or otherwise shareable. In some examples, the virtual memory 136 may serve as a binding target specifically for sharable resources, and, in some instances, all shareable resources may only be bound to the virtual memory 136. In some examples, the shareable resource(s) may be bound to the portion(s) of the virtual memory 136 allocated for binding to the shareable resource(s). In the case of shareable/static resources, the resource binder 116 may bind the shareable resource(s) to the virtual memory allocations, and map the virtual memory allocations to physical memory allocations.

As such, the method 700, at block B706, may include allocating physical memory. For instance, the memory allocator 112 may allocate one or more portions of the physical memory 138 for the shareable resource(s). That is, after allocating the portion(s) of the virtual memory 136 that is to be bound to the shareable resource(s), the resource manager 106 may allocate the portion(s) of the dedicated, physical memory 138 for storing the shareable resources. Then, at block B708, the method 700 may include mapping the virtual memory to the physical memory. For instance, the mapper 118 may map the portion(s) of the virtual memory 136 bound with the shareable resource(s) to the portion(s) of the physical memory 138 allocated to store the shareable resource(s).

The method 700, at block B710, may include populating the shareable resource(s) and computing an identifier(s) corresponding to the shareable resource(s). For instance, the application 102 may submit a request or command to the resource population API 132 of the graphics API 104 to populate the newly created, shareable resource(s). In some examples, once the memory mapping is done between the virtual memory 136 and the physical memory 138, the application 102 may perform read and/or write operations to the virtual memory 136 as usual. That is, the application 102 may start data transfer to/from the virtual memory 136 since the virtual memory has a page(s) of the physical memory 138 mapped to it. Additionally, based at least on the shareable resource(s) being populated, the resource ID generator 120 may compute an identifier(s) corresponding to the shareable resource(s). The identifier(s) may include a hash value(s) corresponding to the shareable resource(s), and the resource ID generator 120 may use one or more hashing algorithms to compute the hash identifier(s).

In some examples, the resource ID generator 120 may be executed using one or more graphics processing units (GPUs) to compute the identifier(s) for the shareable resource(s). As described above and herein, in systems where resources and memory are managed in the driver, identifiers may easily be computed from the resource content to identify copies of the same resource. However, in systems where resources are managed and populated by an application, the system driver may not have access to the resource content to generate hashes from the host (e.g., CPU). Thus, the system(s) of the present disclosure, in some instances, may compute the resource identifier(s) by moving the operation to the GPUs. In some examples, the resource ID generator 120 may generate the identifier(s) as a side effect of moving memory. For instance, the identifier(s) may be maintained in a database associated with the physical memory, with its value being computed every time a memory transfer affected the content of that memory. In some instances, this may be performed automatically by a transfer mechanism in the GPU, a mechanism the GPU uses to facilitate transfers, and/or another system component (e.g., a running checksum calculator that automatically fills a table with checksums for every 64k/2 MB/etc. portion of memory transferred).

The method 700, at block B712, may include querying a database(s) for a duplicate resource(s) using the identifier(s). For instance, the duplicate resource detector 122 may use the identifier(s) to query the database(s) for the duplicate resource(s). In some examples, the database(s) may be used to store at least data indicating associations between the resource identifier(s) and the portion(s) of the physical memory 138 allocated for the shareable resource(s). For instance, and for a resource(s), the database(s) may store data indicating an identifier(s) corresponding to the resource(s) and the portion (e.g., location, address, etc.) of the physical memory 138 allocated to store the resource(s). As such, to determine whether at least one instance of the shareable resource(s) has been stored in the physical memory 138, the duplicate resource detector 122 may query the database(s) using the identifier(s) for the shareable resource(s).

The method 700, at block B714, may include determining whether the duplicate resource(s) is present. For instance, the duplicate resource detector 122 may determine, based on the query, whether the newly created, shareable resource(s) is a duplicate (e.g., copy) of another resource(s) already stored in the physical memory 138. In some examples, if the identifier(s) appears one or more times in the database(s) and/or one or more portions of the physical memory 138 are listed as being bound to the shareable resource(s) corresponding to queried identifier(s), the duplicate resource detector 122 may determine that one or more copies of the shareable resource(s) exist. If, at block B714, it is determined that the newly created, shareable resource(s) is an original resource(s) (e.g., no other copies or duplicates are stored in the physical memory 138), the method 700 may proceed to block B716. On the other hand, if it is determined that the newly created, shareable resource(s) is a duplicative resource(s), the method 700 may proceed to block B718.

The method 700, at block B716, may include updating the database(s). For instance, the resource manager 106 may update the database(s) to include data indicating an association between the identifier(s) of the shareable resource(s) and the portion(s) of the physical memory 138 allocated to store the shareable resource(s). In this way, the duplicate resource detector 122 may later query the database(s) when a new resource(s) is created to determine whether the new resource(s) is a duplicate of one or more other resources already stored in the physical memory 138.

The method 700, at block B718, may include remapping the virtual memory. For instance, the virtual memory may be remapped to an existing, physical memory allocation for the duplicate resource(s). In some instances, the mapper 118 may remap the portion(s) of the virtual memory 136 bound to the newly created, shareable resource(s) to be mapped to the allocated portions of the physical memory 138 storing the shareable resource(s). In other words, the virtual memory 136 may be remapped from the portion(s) of the physical memory 138 allocated in block B706 to be mapped to one or more portions of the physical memory 138 that was/were already storing a copy(ies) of the shareable resource(s) prior to block B706.

The method 700, at block B720, may include releasing the physical memory. For instance, once the remapping is complete, the resource consolidator 124 may cause the portion(s) of the physical memory 138 allocated in block B706 to be released. In some examples, the resource consolidator 124 may submit the deallocation command(s) 142 to release the portion(s) of the physical memory 138. In this way, the released portion(s) of the physical memory 138 may be reused or reallocated for storing other resources or data, allowing servers to achieve greater density (e.g., run more instances of the application 102 on a single server or group of servers) and greater computing resource usage.

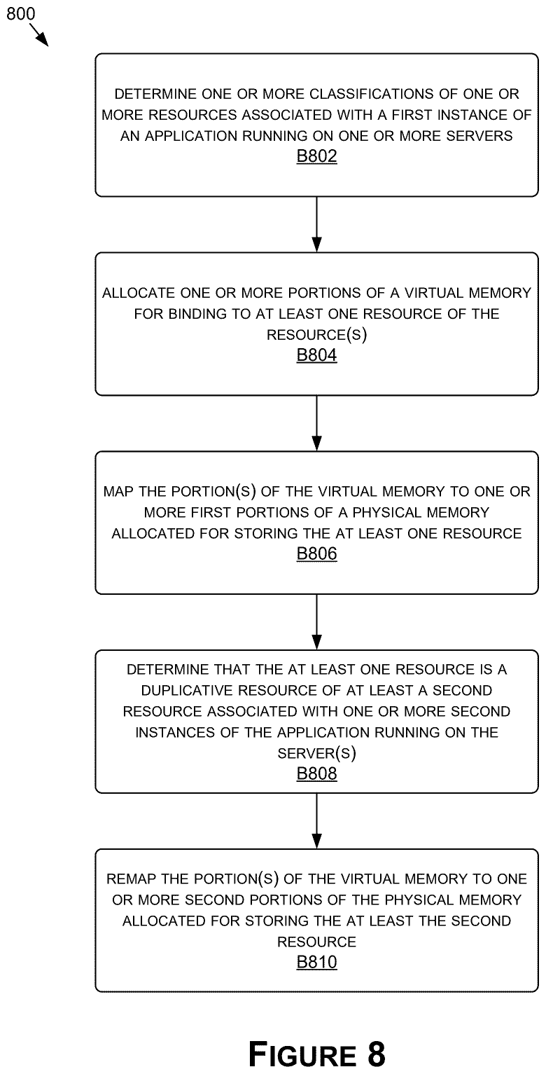

FIG. 8 is a flow diagram illustrating an example method 800 for remapping virtual memory from a first physical memory allocation to a second physical memory allocation, in accordance with some embodiments of the present disclosure. The method 800, at block B802, may include determining one or more classifications of one or more resources associated with a first instance of an application running on one or more servers. For instance, the classifier 108 may determine the classification(s) of the resource(s) associated with the first instance of the application 102, which may be running on the server(s). In some examples, the classifier 108 may determine the classification(s) based at least on metadata corresponding to the resource(s). As an example, the classifier 108 may evaluate properties included in the metadata used to create the resource(s). In some examples, if at least one property of the properties indicates the resource(s) is a dynamic resource, the classifier 108 may classify the resource(s) as a non-shareable, or dynamic resource. Otherwise, if none of the properties indicates the resource(s) is a dynamic resource, the classifier 108 may classify the resource(s) as a shareable, or static resource.

The method 800, at block B804, may include allocating one or more portions of a virtual memory for binding to at least one resource of the resource(s). For instance, the memory allocator 112 may allocate the portion(s) of the virtual memory 136 for binding to the at least one resource. In some examples, the allocation of the portion(s) of the virtual memory may be based at least on the classification(s). For example, if the classification(s) indicate the resource(s) is a shareable resource(s), the portion(s) of the virtual memory may be allocated. Otherwise, if the resource(s) is a non-shareable resource(s), physical memory 138 may be allocated. In some examples, the allocation of the virtual memory may be based at least on the type of memory requested by the application or the type of memory requested for allocation by a graphics API. For instance, if the requested memory is shareable-type memory, the virtual memory may be allocated.

The method 800, at block B806, may include mapping the portion(s) of the virtual memory to one or more first portions of a physical memory allocated for storing the at least one resource. For instance, the mapper 118 may map the portion(s) of the virtual memory 136 to the first portion(s) of the physical memory 138. In some examples, the first portion(s) of the physical memory 138 may be allocated at least partially responsive to the allocation of the portions(s) of the virtual memory 136. In various examples, once the mapping is complete, the application may begin transferring data to and from the virtual memory.

The method 800, at block B808, may include determining that the at least one resource is a duplicative resource of at least a second resource associated with one or more second instances of the application running on the server(s). For instance, the duplicate resource detector 122 may determine that the at least one resource is the duplicative resource of the at least the second resource associated with the second instance(s) of the application 102 running on the server(s). In some examples, an identifier corresponding to the at least one resource may be computed and used to query a database(s) and/or the physical memory 138 to determine whether the at least one resource is the duplicative resource.

The method 800, at block B810, may include remapping the portion(s) of the virtual memory to one or more second portions of the physical memory allocated for storing the at least the second resource. For instance, the mapper 118 may remap the portion(s) of the virtual memory 136 to the second portion(s) of the physical memory 138 allocated for storing the at least the second resource. In some examples, the remapping may be performed based at least on the at least one resource being the duplicative resource. For instance, because the first resource is duplicative (e.g., a copy of, the same as, etc.) of the second resource, the system(s) may remap the virtual memory to the second portion(s) of the physical memory already storing the second resource. Additionally, the system(s) may cause a release of the first portion(s) of the physical memory based at least on the remapping.

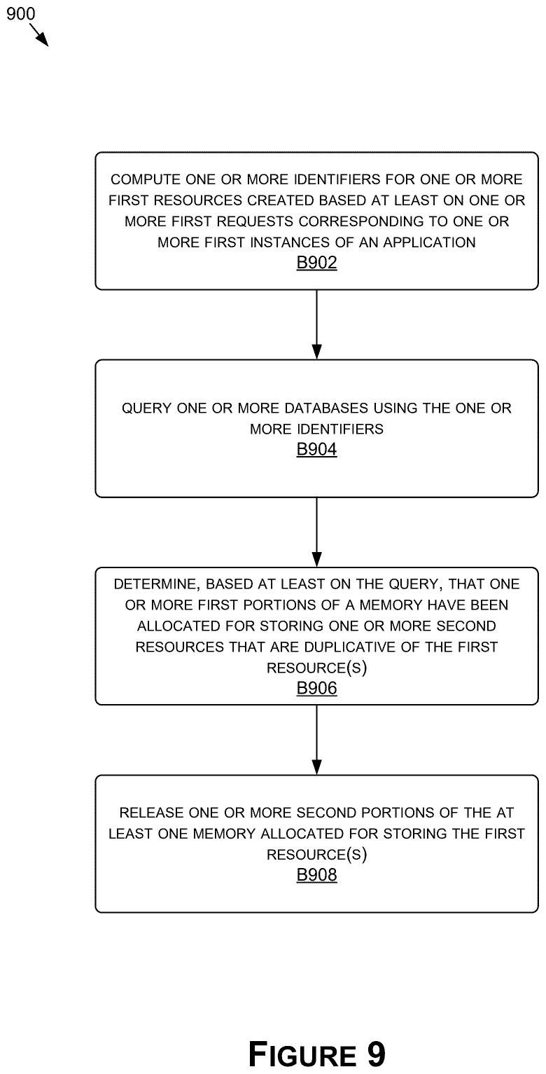

FIG. 9 is a flow diagram illustrating an example method 900 for consolidating duplicative resources and releasing physical memory allocations, in accordance with some embodiments of the present disclosure. The method 900, at block B902, may include computing one or more identifiers for one or more first resources created based at least on one or more first requests corresponding to one or more first instances of an application. For instance, the resource ID generator 120 may compute the identifier(s) for the first resource(s). The identifier(s) may include a hash value(s) corresponding to the first resource(s), and the resource ID generator 120 may use one or more hashing algorithms to compute the hash identifier(s). In some examples, the computation of the identifier(s) may be based at least on the one or more first instances of the application submitting one or more commands to populate the first resource(s). Additionally, in some examples, the resource ID generator 120 may be executed using one or more graphics processing units (GPUs) to compute the identifier(s).

The method 900, at block B904, may include querying one or more databases using the identifier(s). For instance, the duplicate resource detector 122 may query the database(s) using the identifier(s). In some examples, querying the database(s) may include searching the database(s) for the presence of the identifier(s).

The method 900, at block B906, may include determining, based at least on the query, that one or more first portions of a memory have been allocated for storing one or more second resources that are duplicative of the first resource(s). For instance, the duplicate resource detector 122 may determine that the first portion(s) of the memory have been allocated for storing the second resource(s) that are duplicative of the first resource(s). In some examples, the memory may correspond to the physical memory 138. Additionally, in some examples, the determination that the first portion(s) of the memory has been allocated for storing the second resource(s) may be based on the query returning a result indicating the identifier(s) is already stored in the database(s) and associated with the first portion(s) of the memory.

The method 900, at block B908, may include releasing one or more second portions of the memory allocated for storing the first resource(s). For instance, the resource consolidator 124 may cause the second portion(s) of the memory allocated for storing the first resource(s) to be released. In some examples, the resource consolidator 124 may submit the deallocation command(s) 142 to release the second portion(s) of the physical memory 138. In this way, the released portion(s) of the physical memory 138 may be reused or reallocated for storing other resources or data, allowing servers to achieve greater density (e.g., run more instances of the application 102 on a single server or group of servers) and greater computing resource usage.

### EXAMPLE PARALLEL PROCESSING ARCHITECTURE

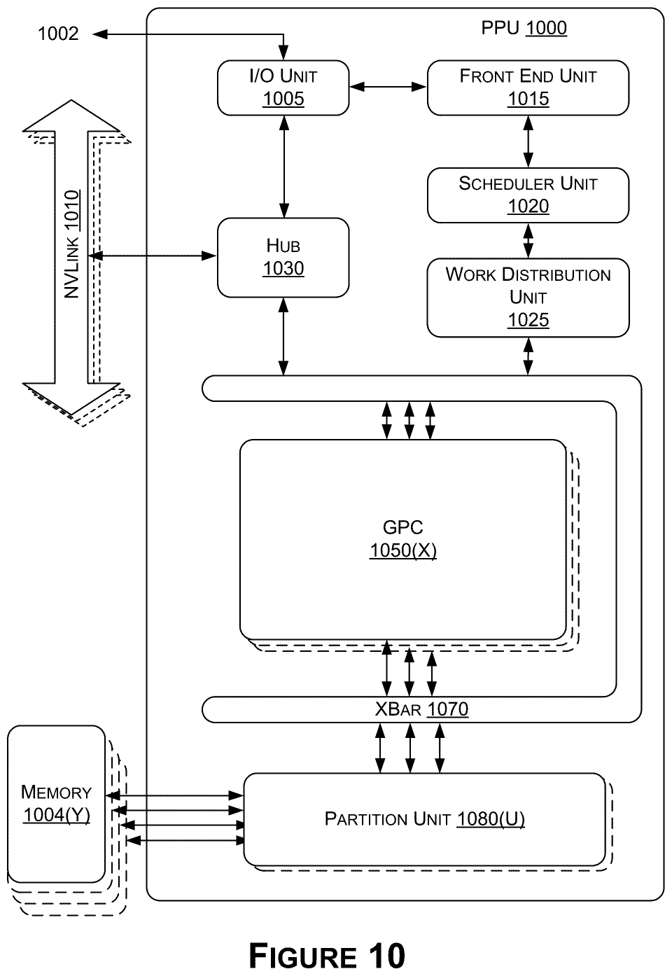

FIG. 10 illustrates an example parallel processing unit (PPU) 1000 suitable for use in implementing at least some embodiments of the present disclosure. In at least one embodiment, the PPU 1000 is a multi-threaded processor that is implemented on one or more integrated circuit devices. The PPU 1000 may have a latency hiding architecture designed to process many threads in parallel. A thread (e.g., a thread of execution) may refer to an instantiation of a set of instructions configured to be executed by the PPU 1000. In at least one embodiment, the PPU 1000 is a graphics processing unit (GPU) configured to implement a graphics rendering pipeline for processing three-dimensional (3D) graphics data in order to generate two-dimensional (2D) image data for display on a display device such as a liquid crystal display (LCD) device. In one or more embodiments, the PPU 1000 may be used for performing general-purpose computations. While one parallel processor is provided herein for illustrative purposes, it should be noted that such processor is set forth for illustrative purposes only, and that any processor may be employed to supplement and/or substitute for the same.

One or more PPUs 1000 may be configured to accelerate, by way of example and not limitation, thousands of High-Performance Computing (HPC), data center, and machine learning applications. The PPU 1000 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, light transport simulation, astronomy, molecular dynamics simulation, financial modeling, robotics, digital twinning, synthetic data generation, factory automation, real-time language translation, online search optimizations, personalized user recommendations, and the like.

As shown in FIG. 10, the PPU 1000 includes an Input/Output (I/O) unit 1005, a front end unit 1015, a scheduler unit 1020, a work distribution unit 1025, a hub 1030, a crossbar (Xbar) 1070, one or more general processing clusters (GPCs) 1050, and one or more partition units 1080. The PPU 1000 may be connected to a host processor or other PPUs 1000 via one or more high-speed NVLink 1010 interconnect. The PPU 1000 may be connected to a host processor or other peripheral devices via an interconnect 1002. The PPU 1000 may also be connected to a local memory comprising a number of memory devices 1004. In at least one embodiment, the local memory may comprise a number of dynamic random-access memory (DRAM) devices. The DRAM devices may be configured as a high-bandwidth memory (HBM) subsystem, with multiple DRAM dies stacked within each device.

The NVLink 1010 interconnect enables systems to scale and include one or more PPUs 1000 combined with one or more CPUs, supports cache coherence between the PPUs 1000 and CPUs, and CPU mastering. Data and/or commands may be transmitted by the NVLink 1010 through the hub 1030 to/from other units of the PPU 1000 such as one or more copy engines, a video encoder, a video decoder, a power management unit, etc. (not explicitly shown).

The I/O unit 1005 may be configured to transmit and receive communications (e.g., commands, data, etc.) from a host processor (not shown) over the interconnect 1002. The I/O unit 1005 may communicate with the host processor directly via the interconnect 1002 or through one or more intermediate devices such as a memory bridge. In at least one embodiment, the I/O unit 1005 may communicate with one or more other processors, such as one or more the PPUs 1000 via the interconnect 1002. In at least one embodiment, the I/O unit 1005 implements a Peripheral Component Interconnect Express (PCIe) interface for communications over a PCIe bus and the interconnect 1002 is a PCIe bus. In at least one embodiment, the I/O unit 1005 may implement other types of well-known interfaces for communicating with external devices.

The I/O unit 1005 decodes packets received via the interconnect 1002. In at least one embodiment, the packets represent commands configured to cause the PPU 1000 to perform various operations. The I/O unit 1005 transmits the decoded commands to various other units of the PPU 1000 as the commands may specify. For example, some commands may be transmitted to the front end unit 1015. Other commands may be transmitted to the hub 1030 or other units of the PPU 1000 such as one or more copy engines, a video encoder, a video decoder, a power management unit, etc. (not explicitly shown). In other words, the I/O unit 1005 may be configured to route communications between and among the various logical units of the PPU 1000.

In at least one embodiment, a program executed by the host processor encodes a command stream in a buffer that provides workloads to the PPU 1000 for processing. A workload may comprise several instructions and data to be processed by those instructions. The buffer may be a region in a memory that is accessible (e.g., read/write) by both the host processor and the PPU 1000. For example, the I/O unit 1005 may be configured to access the buffer in a system memory connected to the interconnect 1002 via memory requests transmitted over the interconnect 1002. In at least one embodiment, the host processor writes the command stream to the buffer and then transmits a pointer to the start of the command stream to the PPU 1000. The front end unit 1015 receives pointers to one or more command streams. The front end unit 1015 manages the one or more streams, reading commands from the streams and forwarding commands to the various units of the PPU 1000.

The front end unit 1015 is coupled to a scheduler unit 1020 that configures the various GPCs 1050 to process tasks defined by the one or more streams. The scheduler unit 1020 is configured to track state information related to the various tasks managed by the scheduler unit 1020. The state may indicate which GPC 1050 a task is assigned to, whether the task is active or inactive, a priority level associated with the task, and so forth. The scheduler unit 1020 manages the execution of a plurality of tasks on the one or more GPCs 1050.

The scheduler unit 1020 is coupled to a work distribution unit 1025 that is configured to dispatch tasks for execution on the GPCs 1050. The work distribution unit 1025 may track a number of scheduled tasks received from the scheduler unit 1020. In at least one embodiment, the work distribution unit 1025 manages a pending task pool and an active task pool for each of the GPCs 1050. The pending task pool may comprise a number of slots (e.g., 32 slots) that contain tasks assigned to be processed by a particular GPC 1050. The active task pool may comprise a number of slots (e.g., 4 slots) for tasks that are actively being processed by the GPCs 1050. As a GPC 1050 finishes the execution of a task, that task may be evicted from the active task pool for the GPC 1050 and one of the other tasks from the pending task pool is selected and scheduled for execution on the GPC 1050. If an active task has been idle on the GPC 1050, such as while waiting for a data dependency to be resolved, then the active task may be evicted from the GPC 1050 and returned to the pending task pool while another task in the pending task pool is selected and scheduled for execution on the GPC 1050.

The work distribution unit 1025 communicates with the one or more GPCs 1050 via XBar 1070. The XBar 1070 is an interconnect network that couples many of the units of the PPU 1000 to other units of the PPU 1000. For example, the XBar 1070 may be configured to couple the work distribution unit 1025 to a particular GPC 1050. Although not shown explicitly, one or more other units of the PPU 1000 may also be connected to the XBar 1070 via the hub 1030.

The tasks are managed by the scheduler unit 1020 and dispatched to a GPC 1050 by the work distribution unit 1025. The GPC 1050 is configured to process the task and generate results. The results may be consumed by other tasks within the GPC 1050, routed to a different GPC 1050 via the XBar 1070, or stored in the memory 1004. The results can be written to the memory 1004 via the partition units 1080, which may implement a memory interface for reading and writing data to/from the memory 1004. The results can be transmitted to another PPU 1000 or CPU via the NVLink 1010. In at least one embodiment, the PPU 1000 includes a number U of partition units 1080 that is equal to the number of separate and distinct memory devices 1004 coupled to the PPU 1000.

In at least one embodiment, a host processor executes a driver kernel that implements an application programming interface (API) that enables one or more applications executing on the host processor to schedule operations for execution on the PPU 1000. In at least one embodiment, multiple compute applications are simultaneously executed by the PPU 1000 and the PPU 1000 provides isolation, quality of service (QoS), and independent address spaces for the multiple compute applications. An application may generate instructions (e.g., API calls) that cause the driver kernel to generate one or more tasks for execution by the PPU 1000. The driver kernel may output tasks to one or more streams being processed by the PPU 1000. Each task may comprise one or more groups of related threads, wherein may be referred to as a warp. In at least one embodiment, a warp comprises 32 related threads that may be executed in parallel. Cooperating threads may refer to a plurality of threads including instructions to perform the task and that may exchange data through shared memory.

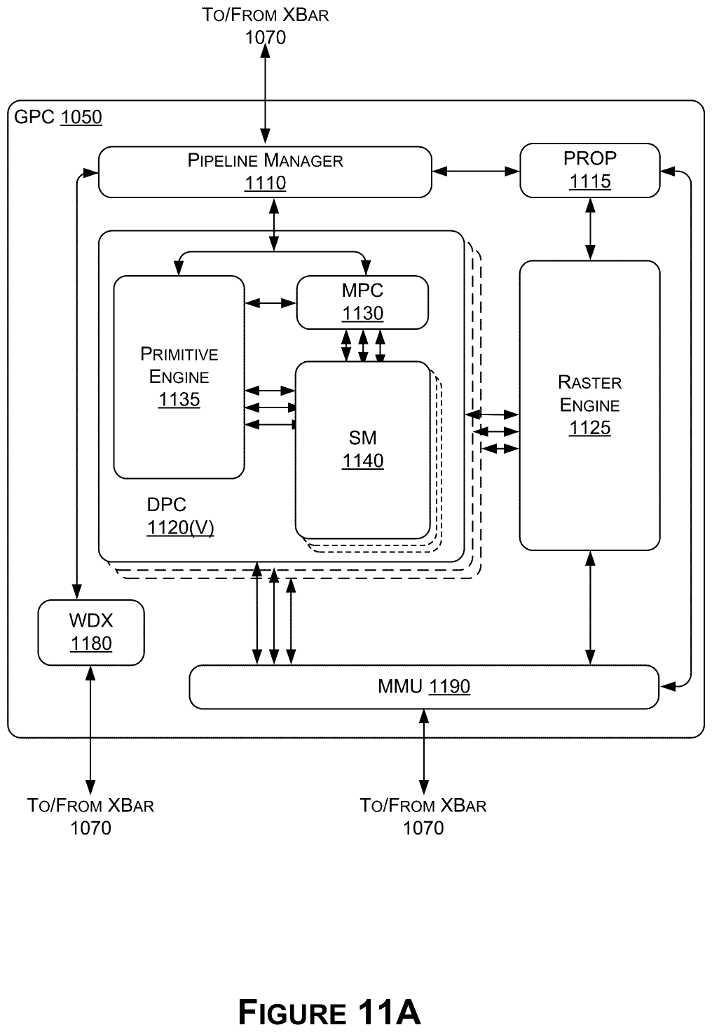

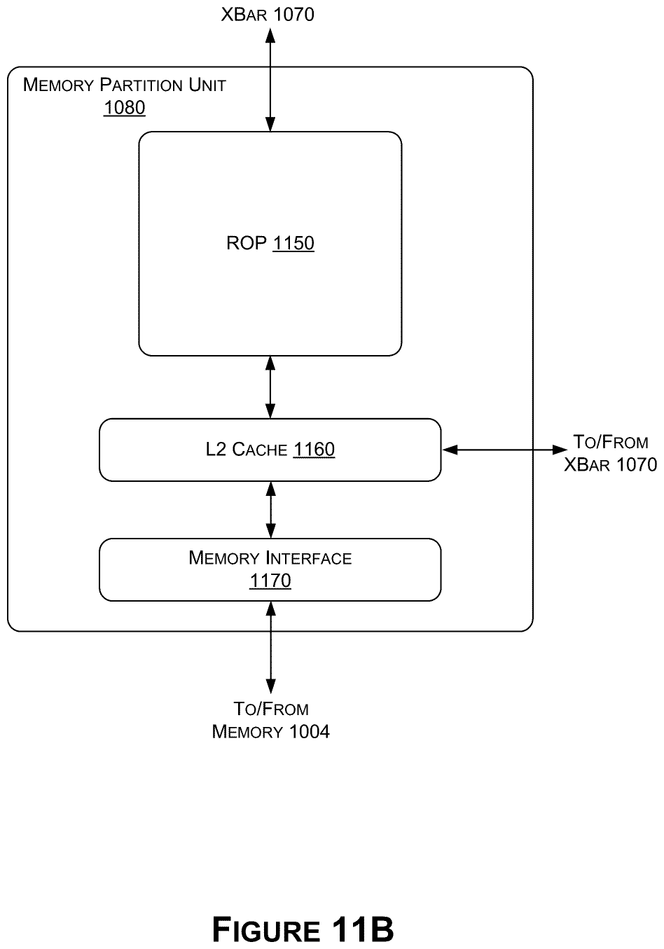

FIG. 11A illustrates an example GPC 1050 of the PPU 1000 of FIG. 10 suitable for use in implementing at least some embodiments of the present disclosure. As shown in FIG. 11A, each GPC 1050 may include a number of hardware units for processing tasks. In at least one embodiment, each GPC 1050 includes a pipeline manager 1110, a pre-raster operations unit (PROP) 1115, a raster engine 1125, a work distribution crossbar (WDX) 1180, a memory management unit (MMU) 1190, and one or more Data Processing Clusters (DPCs) 1120. It will be appreciated that the GPC 1050 of FIG. 11A may include other hardware units in lieu of or in addition to the units shown in FIG. 11A.

In at least one embodiment, the operation of the GPC 1050 is controlled by the pipeline manager 1110. The pipeline manager 1110 manages the configuration of the one or more DPCs 1120 for processing tasks allocated to the GPC 1050. In at least one embodiment, the pipeline manager 1110 may configure at least one of the one or more DPCs 1120 to implement at least a portion of a graphics rendering pipeline. For example, a DPC 1120 may be configured to execute a vertex shader program on the programmable streaming multiprocessor (SM) 1140. The pipeline manager 1110 may also be configured to route packets received from the work distribution unit 1025 to the appropriate logical units within the GPC 1050. For example, some packets may be routed to fixed function hardware units in the PROP 1115 and/or raster engine 1125 while other packets may be routed to the DPCs 1120 for processing by the primitive engine 1135 or the SM 1140. In at least one embodiment, the pipeline manager 1110 may configure at least one of the one or more DPCs 1120 to implement a neural network model and/or a computing pipeline.

The PROP unit 1115 may be configured to route data generated by the raster engine 1125 and the DPCs 1120 to a Raster Operations (ROP) unit. The PROP unit 1115 may also be configured to perform optimizations for color blending, organizing pixel data, performing address translations, and the like.

The raster engine 1125 may include a number of fixed function hardware units configured to perform various raster operations. In at least one embodiment, the raster engine 1125 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1125 comprises fragments to be processed, for example, by a fragment shader implemented within a DPC 1120.

Each DPC 1120 included in the GPC 1050 includes an M-Pipe Controller (MPC) 1130, a primitive engine 1135, and one or more SMs 1140. The MPC 1130 controls the operation of the DPC 1120, routing packets received from the pipeline manager 1110 to the appropriate units in the DPC 1120. For example, packets associated with a vertex may be routed to the primitive engine 1135, which is configured to fetch vertex attributes associated with the vertex from the memory 1004. In contrast, packets associated with a shader program may be transmitted to the SM 1140.

The SM 1140 comprises a programmable streaming processor that is configured to process tasks represented by a number of threads. Each SM 1140 is multi-threaded and configured to execute a plurality of threads (e.g., 32 threads) from a particular group of threads concurrently. In at least one embodiment, the SM 1140 implements a SIMD (Single-Instruction, Multiple-Data) architecture where each thread in a group of threads (e.g., a warp) is configured to process a different set of data based on the same set of instructions. All threads in the group of threads execute the same instructions. In at least one embodiment, the SM 1140 implements a SIMT (Single-Instruction, Multiple Thread) architecture where each thread in a group of threads is configured to process a different set of data based on the same set of instructions, but where individual threads in the group of threads are allowed to diverge during execution. In at least one embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

The MMU 1190 may provide an interface between the GPC 1050 and the partition unit 1080. The MMU 1190 may provide translation of virtual addresses into physical addresses, memory protection, and arbitration of memory requests. In at least one embodiment, the MMU 1190 provides one or more translation lookaside buffers (TLBs) for performing translation of virtual addresses into physical addresses in the memory 1004.

FIG. 11B illustrates an example memory partition unit 1080 of the PPU 1000 of FIG. 10 suitable for use in implementing at least some embodiments of the present disclosure. As shown in FIG. 11B, the memory partition unit 1080 includes a Raster Operations (ROP) unit 1150, a level two (L2) cache 1160, and a memory interface 1170. The memory interface 1170 may be coupled to the memory 1004. Memory interface 1170 may implement 32, 64, 128, 1024-bit data buses, or the like, for high-speed data transfer. In at least one embodiment, the PPU 1000 incorporates U memory interfaces 1170, one memory interface 1170 per pair of partition units 1080, where each pair of partition units 1080 is connected to a corresponding memory device 1004. For example, the PPU 1000 may be connected to up to Y memory devices 1004, such as high bandwidth memory stacks or graphics double-data-rate, version 5, synchronous dynamic random access memory, or other types of persistent storage.

In at least one embodiment, the memory interface 1170 implements an HBM2 memory interface and Y equals half U. In at least one embodiment, the HBM2 memory stacks are located on the same physical package as the PPU 1000, providing substantial power and area savings compared with conventional GDDR5 SDRAM systems. In at least one embodiment, each HBM2 stack includes four memory dies and Y equals 4, with HBM2 stack including two 128-bit channels per die for a total of 8 channels and a data bus width of 1024 bits.

In at least one embodiment, the memory 1004 supports Single-Error Correcting Double-Error Detecting (SECDED) Error Correction Code (ECC) to protect data. ECC provides high reliability for compute applications that are sensitive to data corruption. Reliability is especially important in large-scale cluster computing environments where the PPUs 1000 process very large datasets and/or run applications for extended periods.

In at least one embodiment, the PPU 1000 implements a multi-level memory hierarchy. In at least one embodiment, the memory partition unit 1080 supports a unified memory to provide a single unified virtual address space for CPU and PPU 1000 memory, enabling data sharing between virtual memory systems. In at least one embodiment the frequency of accesses by a PPU 1000 to memory located on other processors is traced to ensure that memory pages are moved to the physical memory of the PPU 1000 that is accessing the pages more frequently. In at least one embodiment, the NVLink 1010 supports address translation services allowing the PPU 1000 to directly access a CPU's page tables and providing full access to CPU memory by the PPU 1000.

In at least one embodiment, copy engines transfer data between multiple PPUs 1000 or between PPUs 1000 and CPUs. The copy engines can generate page faults for addresses that are not mapped into the page tables. The memory partition unit 1080 can then service the page faults, mapping the addresses into the page table, after which the copy engine can perform the transfer. With hardware page faulting, addresses can be passed to the copy engines without worrying if the memory pages are resident, and the copy process is transparent.

Data from the memory 1004 or other system memory may be fetched by the memory partition unit 1080 and stored in the L2 cache 1160, which is located on-chip and is shared between the various GPCs 1050. As shown, each memory partition unit 1080 includes a portion of the L2 cache 1160 associated with a corresponding memory device 1004. Lower level caches may then be implemented in various units within the GPCs 1050. For example, each of the SMs 1140 may implement a level one (L1) cache. The L1 cache is private memory that may be dedicated to a particular SM 1140. Data from the L2 cache 1160 may be fetched and stored in each of the L1 caches for processing in the functional units of the SMs 1140. The L2 cache 1160 is coupled to the memory interface 1170 and the XBar 1070.

The ROP unit 1150 performs graphics raster operations related to pixel color, such as color compression, pixel blending, and the like. The ROP unit 1150 also implements depth testing in conjunction with the raster engine 1125, receiving a depth for a sample location associated with a pixel fragment from the culling engine of the raster engine 1125. The depth is tested against a corresponding depth in a depth buffer for a sample location associated with the fragment. If the fragment passes the depth test for the sample location, then the ROP unit 1150 updates the depth buffer and transmits a result of the depth test to the raster engine 1125. It will be appreciated that the number of partition units 1080 may be different than the number of GPCs 1050 and, therefore, each ROP unit 1150 may be coupled to each of the GPCs 1050. The ROP unit 1150 may track packets received from the different GPCs 1050 and determine which GPC 1050 that a result generated by the ROP unit 1150 is routed to through the Xbar 1070. Although the ROP unit 1150 is included within the memory partition unit 1080 in FIG. 11B, in other examples, the ROP unit 1150 may be outside of the memory partition unit 1080. For example, the ROP unit 1150 may reside in the GPC 1050 or another unit.

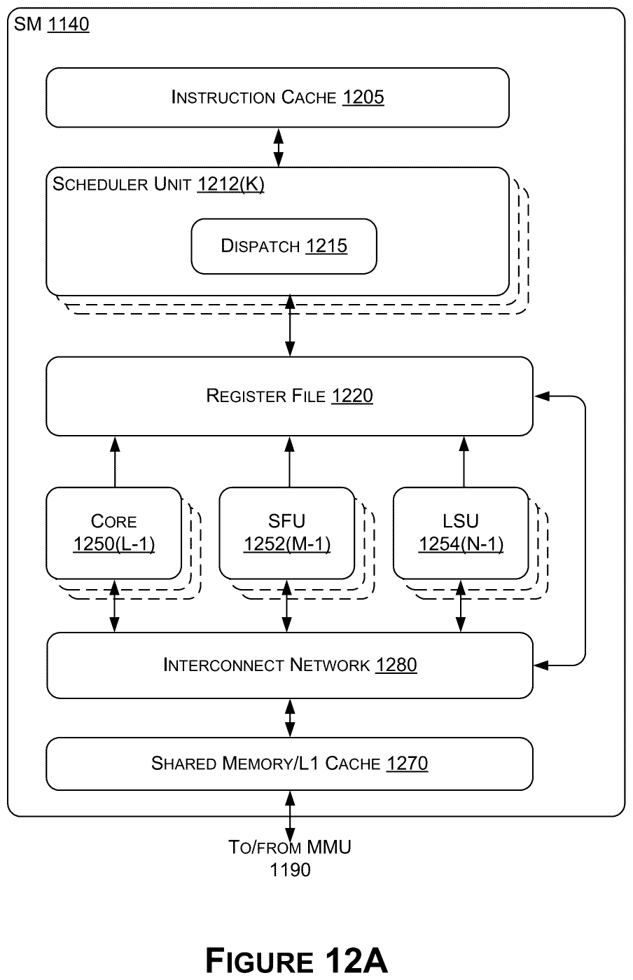

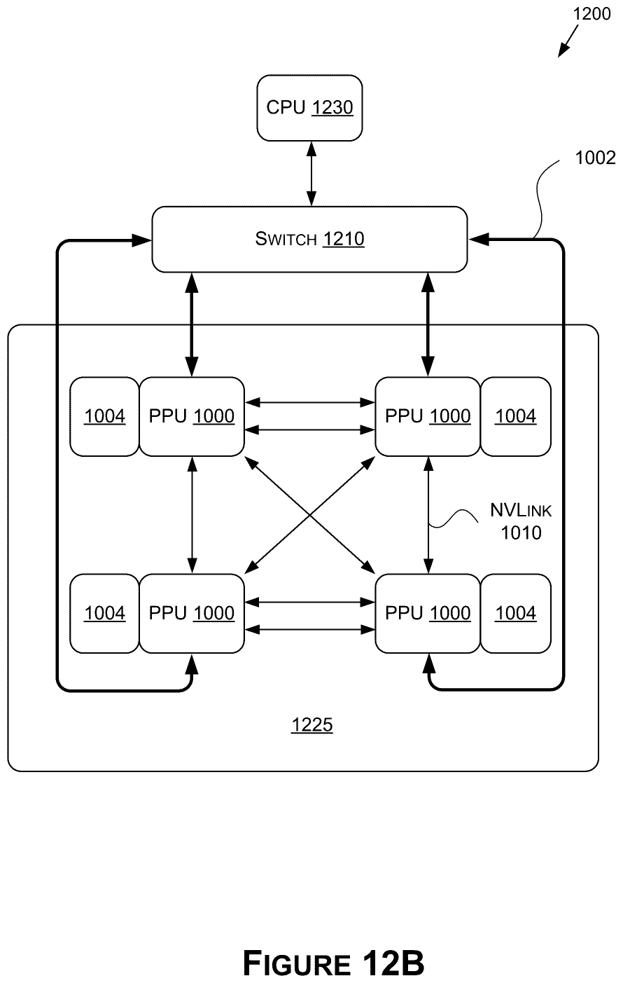

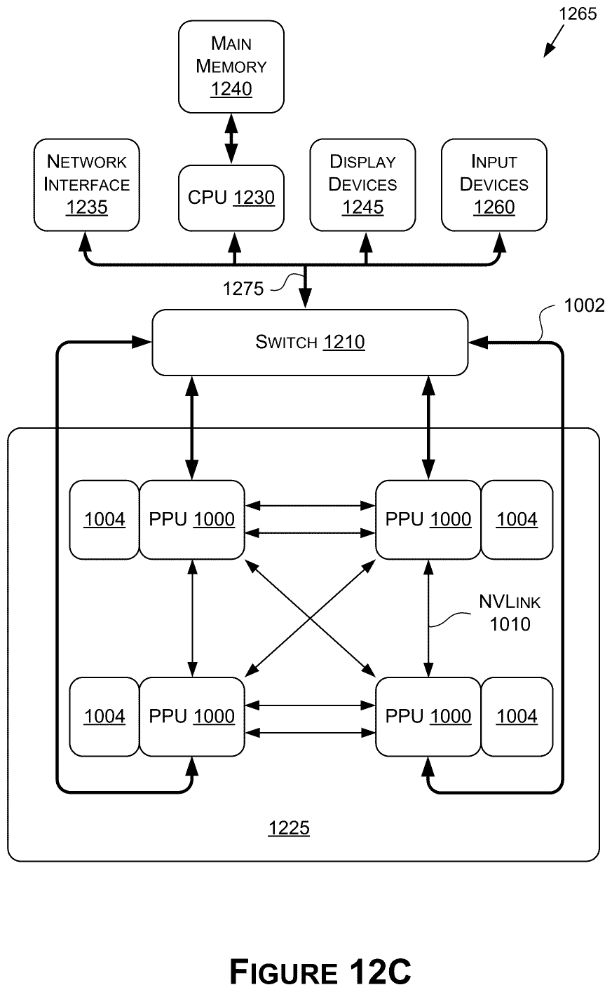

FIG. 12A illustrates an example of the streaming multiprocessor 1140 of FIG. 11A suitable for use in implementing at least some embodiments of the present disclosure. As shown in FIG. 12A, the SM 1140 includes an instruction cache 1205, one or more scheduler units 1212, a register file 1220, one or more processing cores 1250, one or more special function units (SFUs) 1252, one or more load/store units (LSUs) 1254, an interconnect network 1280, and a shared memory/L1 cache 1270.

As described herein, the work distribution unit 1025 dispatches tasks for execution on the GPCs 1050 of the PPU 1000. The tasks may be allocated to a particular DPC 1120 within a GPC 1050 and, if the task is associated with a shader program, the task may be allocated to an SM 1140. The scheduler unit 1212 may receive the tasks from the work distribution unit 1025 and manage instruction scheduling for one or more thread blocks assigned to the SM 1140. The scheduler unit 1212 may schedule thread blocks for execution as warps of parallel threads, where each thread block is allocated at least one warp. In at least one embodiment, each warp executes 32 threads. The scheduler unit 1212 may manage a plurality of different thread blocks, allocating the warps to the different thread blocks and then dispatching instructions from the plurality of different cooperative groups to the various functional units (e.g., cores 1250, SFUs 1252, and LSUs 1254) during each clock cycle.

Cooperative Groups may refer to a programming model for organizing groups of communicating threads that allows developers to express the granularity at which threads are communicating, enabling the expression of richer, more efficient parallel decompositions. Cooperative launch APIs may support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 1215 may be configured to transmit instructions to one or more of the functional units. In at least one embodiment, the scheduler unit 1212 includes two dispatch units 1215 that enable two different instructions from the same warp to be dispatched during each clock cycle. In at least embodiment, each scheduler unit 1212 may include a single dispatch unit 1215 or additional dispatch units 1215.

Each SM 1140 may include a register file 1220 that provides a set of registers for the functional units of the SM 1140. In at least one embodiment, the register file 1220 is divided between each of the functional units such that each functional unit is allocated a dedicated portion of the register file 1220. In at least one embodiment, the register file 1220 is divided between the different warps being executed by the SM 1140. The register file 1220 provides temporary storage for operands connected to the data paths of the functional units.

Each SM 1140 may include L processing cores 1250. In at least one embodiment, the SM 1140 includes a large number (e.g., 128, etc.) of distinct processing cores 1250. Each core 1250 may include a fully-pipelined, single-precision, double-precision, and/or mixed precision processing unit that includes a floating point arithmetic logic unit and an integer arithmetic logic unit. In at least one embodiment, the floating point arithmetic logic units implement the IEEE 754-2008 standard for floating point arithmetic. In at least one embodiment, the cores 1250 include 64 single-precision (32-bit) floating point cores, 64 integer cores, 32 double-precision (64-bit) floating point cores, and 8 tensor cores.

Tensor cores configured to perform matrix operations, and, in at least one embodiment, one or more tensor cores are included in the cores 1250. In particular, the tensor cores may be configured to perform deep learning matrix arithmetic, such as convolution operations for neural network training and inferencing. In at least one embodiment, each tensor core operates on a 4×4 matrix and performs a matrix multiply and accumulate operation D=A×B+C, where A, B, C, and D are 4×4 matrices.

Training complex neural networks requires massive amounts of parallel computing performance, including floating-point multiplications and additions that are supported by the PPU 1000. Inferencing is less compute-intensive than training, being a latency-sensitive process where a trained neural network is applied to new inputs it has not seen before to classify images, translate speech, and infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 1000 may form a computing platform capable of delivering performance required for deep neural network-based artificial intelligence and machine learning applications.

In at least one embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores may be used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 1140 may also include M SFUs 1252 that perform special functions (e.g., attribute evaluation, reciprocal square root, and the like). In at least one embodiment, the SFUs 1252 may include a tree traversal unit configured to traverse a hierarchical tree data structure. In at least one embodiment, the SFUs 1252 may include texture unit configured to perform texture map filtering operations. In at least one embodiment, the texture units are configured to load texture maps (e.g., a 2D array of texels) from the memory 1004 and sample the texture maps to produce sampled texture values for use in shader programs executed by the SM 1140. In at least one embodiment, the texture maps are stored in the shared memory/L1 cache 1170. The texture units implement texture operations such as filtering operations using mip-maps (e.g., texture maps of varying levels of detail). In at least one embodiment, each SM 1140 includes two texture units.

Each SM 1140 may also include N LSUs 1254 that implement load and store operations between the shared memory/L1 cache 1270 and the register file 1220. Each SM 1140 may include an interconnect network 1280 that connects each of the functional units to the register file 1220 and the LSU 1254 to the register file 1220, shared memory/L1 cache 1270. In at least one embodiment, the interconnect network 1280 is a crossbar that can be configured to connect any of the functional units to any of the registers in the register file 1220 and connect the LSUs 1254 to the register file and memory locations in shared memory/L1 cache 1270.

The shared memory/L1 cache 1270 may include an array of on-chip memory that allows for data storage and communication between the SM 1140 and the primitive engine 1135 and between threads in the SM 1140. In at least one embodiment, the shared memory/L1 cache 1270 comprises 128 KB of storage capacity and is in the path from the SM 1140 to the partition unit 1080. The shared memory/L1 cache 1270 can be used to cache reads and writes. One or more of the shared memory/L1 cache 1270, L2 cache 1160, and memory 1004 may be backing stores.

Combining data cache and shared memory functionality into a single memory block may provide the best overall performance for both types of memory accesses. The capacity may be usable as a cache by programs that do not use shared memory. For example, if shared memory is configured to use half of the capacity, texture and load/store operations can use the remaining capacity. Integration within the shared memory/L1 cache 1270 may enable the shared memory/L1 cache 1270 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 10, may be bypassed, creating a much simpler programming model. In the general-purpose parallel computation configuration, the work distribution unit 1025 may assign and distribute blocks of threads directly to the DPCs 1120. The threads in a block may execute the same program, using a unique thread ID in the calculation to ensure each thread generates unique results, using the SM 1140 to execute the program and perform calculations, shared memory/L1 cache 1270 to communicate between threads, and the LSU 1254 to read and write global memory through the shared memory/L1 cache 1270 and the memory partition unit 1080. When configured for general purpose parallel computation, the SM 1140 can also write commands that the scheduler unit 1020 can use to launch new work on the DPCs 1120.

The PPU 1000 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In at least one embodiment, the PPU 1000 is embodied on a single semiconductor substrate. In at least one embodiment, the PPU 1000 is included in a system-on-a-chip (SoC) along with one or more other devices such as additional PPUs 1000, the memory, a reduced instruction set computer (RISC) CPU, a memory management unit (MMU), a digital-to-analog converter (DAC), and the like.

In at least one embodiment, the PPU 1000 may be included on a graphics card that includes one or more memory devices 1004. The graphics card may be configured to interface with a PCIe slot on a motherboard of a desktop computer. In at least one embodiment, the PPU 1000 may be an integrated graphics processing unit (iGPU) or parallel processor included in the chipset of the motherboard.

### EXAMPLE OF A COMPUTING SYSTEM

Systems with multiple GPUs and CPUs are used in a variety of industries as developers expose and use more parallelism in applications such as artificial intelligence computing. High-performance GPU-accelerated systems with tens to many thousands or more of compute nodes are deployed in data centers, research facilities, and supercomputers to solve ever larger problems. As the number of processing devices within the high-performance systems increases, the communication and data transfer mechanisms need to scale to support the increased bandwidth.

FIG. 12B is an example conceptual diagram of a processing system 1200 implemented using the PPU 1000 of FIG. 10 suitable for use in implementing at least some embodiments of the present disclosure. The processing system 1200 includes a CPU 1230, switch 1210, and multiple PPUs 1000 each and respective memories 1004. The NVLink 1010 provides high-speed communication links between each of the PPUs 1000. Although a particular number of NVLink 1010 and interconnect 1002 connections are illustrated in FIG. 12B, the number of connections to each PPU 1000 and the CPU 1230 may vary. The switch 1210 interfaces between the interconnect 1002 and the CPU 1230. The PPUs 1000, memories 1004, and NVLinks 1010 may be situated on a single semiconductor platform to form a parallel processing system 1225. In at least one embodiment, the switch 1210 supports two or more protocols to interface between various different connections and/or links.

In at least embodiment (not shown), the NVLink 1010 provides one or more high-speed communication links between each of the PPUs 1000 and the CPU 1230 and the switch 1210 interfaces between the interconnect 1002 and each of the PPUs 1000. The PPUs 1000, memories 1004, and interconnect 1002 may be situated on a single semiconductor platform to form a parallel processing module 1225. In at least one embodiment (not shown), the interconnect 1002 provides one or more communication links between each of the PPUs 1000 and the CPU 1230 and the switch 1210 interfaces between each of the PPUs 1000 using the NVLink 1010 to provide one or more high-speed communication links between the PPUs 1000. In at least one embodiment (not shown), the NVLink 1010 provides one or more high-speed communication links between the PPUs 1000 and the CPU 1230 through the switch 1210. In yet at least one embodiment (not shown), the interconnect 1002 provides one or more communication links between each of the PPUs 1000 directly. One or more of the NVLink 1010 high-speed communication links may be implemented as a physical NVLink interconnect or either an on-chip or on-die interconnect using the same protocol as the NVLink 1010.

In the context of the present description, a single semiconductor platform may refer to a sole unitary semiconductor-based integrated circuit fabricated on a die or chip. The term single semiconductor platform may also refer to multi-chip modules with increased connectivity which simulate on-chip operation and make substantial improvements over using a conventional bus implementation. Of course, the various circuits or devices may also be situated separately or in various combinations of semiconductor platforms per the desires of the user. Alternately, the parallel processing module 1225 may be implemented as a circuit board substrate and each of the PPUs 1000 and/or memories 1004 may be packaged devices. In at least one embodiment, the CPU 1230, switch 1210, and the parallel processing module 1225 are situated on a single semiconductor platform.

In at least one embodiment, the signaling rate of each NVLink 1010 is 20 to 25 Gigabits/second and each PPU 1000 includes six NVLink 1010 interfaces (as shown in FIG. 12B, five NVLink 1010 interfaces are included for each PPU 1000). Each NVLink 1010 may provide a data transfer rate of 25 Gigabytes/second in each direction, with six links providing 1000 Gigabytes/second. The NVLinks 1010 can be used exclusively for PPU-to-PPU communication as shown in FIG. 12B, or some combination of PPU-to-PPU and PPU-to-CPU, when the CPU 1230 also includes one or more NVLink 1010 interfaces.

In at least one embodiment, the NVLink 1010 allows direct load/store/atomic access from the CPU 1230 to each PPU's 1000 memory 1004. In at least one embodiment, the NVLink 1010 supports coherency operations, allowing data read from the memories 1004 to be stored in the cache hierarchy of the CPU 1230, reducing cache access latency for the CPU 1230. In at least one embodiment, the NVLink 1010 includes support for Address Translation Services (ATS), allowing the PPU 1000 to directly access page tables within the CPU 1230. One or more of the NVLinks 1010 may also be configured to operate in a low-power mode.

FIG. 12C illustrates an example system 1265 in which the various architecture and/or functionality of the various previous embodiments may be implemented suitable for use in implementing at least some embodiments of the present disclosure.

As shown, a system 1265 is provided including at least one central processing unit (CPU) 1230 that is connected to a communication bus 1275. The communication bus 1275 may be implemented using any suitable protocol, such as PCI (Peripheral Component Interconnect), PCI-Express, AGP (Accelerated Graphics Port), HyperTransport, or any other bus or point-to-point communication protocol(s). The system 1265 also includes a main memory 1240. Control logic (software) and data are stored in the main memory 1240 which may take the form of random access memory (RAM).

The system 1265 also includes input devices 1260, the parallel processing system 1225, and display devices 1245, e.g. a conventional CRT (cathode ray tube), LCD (liquid crystal display), LED (light emitting diode), plasma display or the like. User input may be received from the input devices 1260, e.g., keyboard, mouse, touchpad, microphone, and the like. Each of the foregoing modules and/or devices may even be situated on a single semiconductor platform to form the system 1265. Alternately, the various modules may also be situated separately or in various combinations of semiconductor platforms per the desires of the user.

Further, the system 1265 may be coupled to a network (e.g., a telecommunications network, local area network (LAN), wireless network, wide area network (WAN) such as the Internet, peer-to-peer network, cable network, or the like) through a network interface 1235 for communication purposes.

The system 1265 may also include a secondary storage (not shown). The secondary storage may include, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive may read from and/or writes to a removable storage unit.

Computer programs, or computer control logic algorithms, may be stored in the main memory 1240 and/or the secondary storage. Such computer programs, when executed, enable the system 1265 to perform various functions. The memory 1240, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1265 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

### RAY TRACING PIPELINE

In at least one embodiment, the PPU 1000 comprises a graphics processing unit (GPU). The PPU 1000 may be configured to receive commands that specify shader programs for processing graphics data. Graphics data may be defined as a set of primitives such as points, lines, triangles, quads, triangle strips, and the like. A primitive may include data that specifies a number of vertices for the primitive (e.g., in a model-space coordinate system) as well as attributes associated with each vertex of the primitive. The PPU 1000 may be configured to process the graphics primitives to generate a frame buffer (e.g., pixel data for each of the pixels of the display).

An application may write model data for a scene (e.g., a collection of vertices and attributes) to a memory such as a system memory or memory 1004. The model data may define each of the objects that may be visible on a display. The application may then make an API call to the driver kernel that requests the model data to be rendered and displayed. The driver kernel may read the model data and write commands to the one or more streams to perform operations to process the model data. The commands may reference different shader programs to be implemented on the SMs 1140 of the PPU 1000. For example, different SMs 1140 may be configured to execute different shader programs.

In at least one embodiment, the model data may be processed to perform one or more ray tracing operations, such as real-time tray tracing, to render the model data to a frame buffer. The contents of the frame buffer may be transmitted to a display controller for display on a display device. Ray tracing may refer to any of a variety of techniques for modeling or simulating light transport and/or other aspects of an environment, for example, for use in generating digital images or otherwise simulating the environment. Thus, while certain embodiments may be described with respect to light transport simulation, they may be applicable to simulating, modeling, and/or measuring any of a variety of aspects of an environment. Non-limiting examples of ray tracing include ray casting, recursive ray tracing, distribution ray tracing, photon mapping, and path tracing.

Ray tracing may be used to simulate a variety of optical effects - such as shadows, reflections, refractions, scattering phenomenon, ambient occlusions, global illuminations, or dispersion phenomenon (such as chromatic aberration). Ray tracing may involve generating ray-traced samples by casting rays in a virtual environment to sample lighting and/or other environmental conditions for pixels. The ray traced samples may be combined and used to determine pixel colors for an image. In at least one embodiment, to conserve computing resources, the lighting conditions may be sparsely sampled, resulting in noisy render data. Temporal accumulation may be used to increase the effective sample count by using information from previous frames. To produce a final render that approximates a render of a fully sampled scene, one or more denoising filters may by be applied to the noisy render data to reduce noise.

Many ray tracing algorithms may cast or shoot rays from a virtual camera, or eye, through a 2D viewing plane (e.g., a pixel plane) out into a 3D scene which may include one or more light sources. Some rays may directly reach the viewing plane from a light source, some may be blocked by an object in the scene causing shadows, and some may reflect or refract off an object before reaching the viewing plane. When the rays intersect objects, the color and lighting information at the points of intersection on object surfaces may contribute to various pixel color and illumination levels of pixels of the viewing plane. Different objects may have different surface properties that can cause them to reflect, refract, or absorb light in different ways, which may be accounted for in ray tracing. Rays may reflect off objects and hit other objects, or travel through the surfaces of transparent objects before reaching a light source, and the color and lighting information from all the intersected objects may contribute to the final pixel colors.

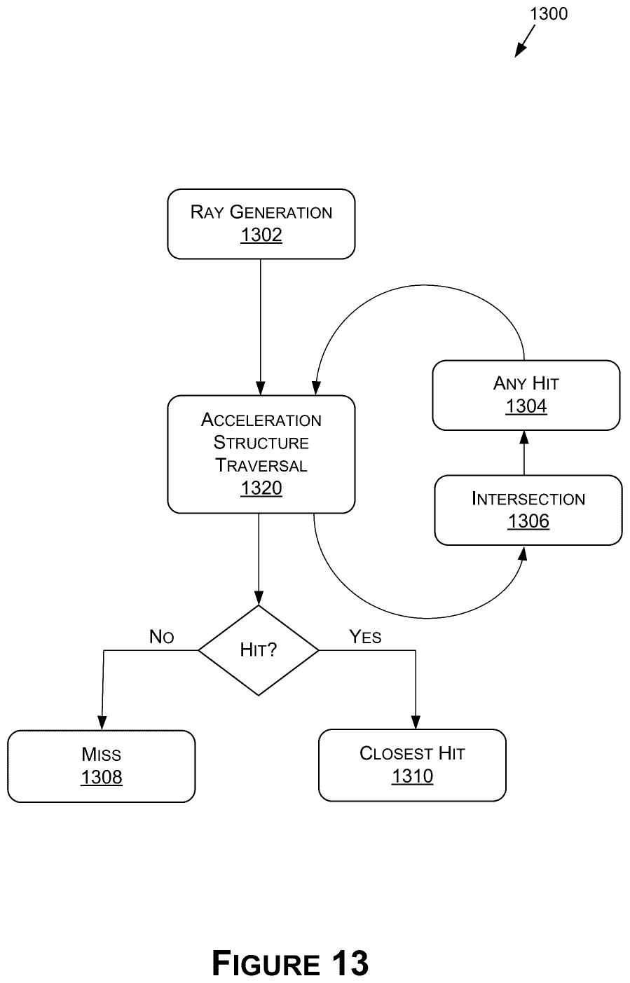

FIG. 13 illustrates an example ray tracing pipeline 1300 suitable for use in implementing at least some embodiments of the present disclosure. By way of example, and not limitations, the ray tracing pipeline 1300 may be implemented by the PPU 1000 of FIG. 10, in accordance with at least one embodiment. The ray tracing pipeline 1300 may include processing steps implemented to generate 2D computer-generated images from 3D geometry data using one or more ray tracing techniques.

In at least one embodiment, the ray tracing pipeline 1300 may be constructed using one or more ray generation shaders 1302, one or more any hit shaders 1304, one or more intersection shaders 1306, one or more miss shaders 1308, and/or one or more closest hit shaders 1310.

The ray tracing pipeline 1300 may be implemented via an application executed by a host processor, such as a CPU. In at least one embodiment, a device driver may implement an application programming interface (API) that defines various functions that can be used by an application in order to generate graphical data for display. The device driver may refer to a software program that includes instructions that control the operation of the PPU 1000, or other PPU used to implement the ray tracing pipeline 1300. The API may provide an abstraction for a programmer that lets a programmer use specialized graphics hardware, such as the PPU 1000, to generate the graphical data without requiring the programmer to use the specific instruction set for the PPU 1000. The application may include an API call that is routed to the device driver for the PPU 1000. The device driver may interpret the API call and perform various operations to respond to the API call. In at least one embodiment, the device driver performs operations by executing instructions on the CPU. In at least one embodiment, the device driver performs operations, at least in part, by launching operations on the PPU 1000 using an input/output interface between the CPU and the PPU 1000. In at least one embodiment, the device driver is configured to implement the ray tracing pipeline 1300 using the hardware of the PPU 1000.

Various programs may be executed within the PPU 1000 in order to implement the various stages of the ray tracing pipeline 1300. For example, the device driver may launch a kernel on the PPU 1000 to execute a stage implementing a ray generation shader 1302 on an SM 1140 (or multiple SMs 1140). The device driver (or the initial kernel executed by the PPU 1000) may also launch other kernels on the PPU 1000 to execute other stages of the ray tracing pipeline 1300.

The ray generation shader 1302 may be the first shader involved in ray tracing dispatch. The ray generation shader 1302 may call a High Level Shader Language (HLSL) function called TraceRay( ). This TraceRay( ) function may cast a single ray into the scene to search for intersections, which may trigger other shaders in the process. In at least one embodiment, the ray generation shader 1302 may call TraceRay( ) any number of times.

An any hit shader 1304 and an intersection shader 1306 may be invoked whenever TraceRay( ) finds a potential intersection between the ray and the scene. The intersection shader 1306 may determine whether the ray intersects an individual geometric primitive—for example a sphere, a subdivision surface, a triangle, or other form of primitive. Once an intersection is found, the any hit shader 1304 may be used to process the intersection further or potentially discard the intersection. An any hit shader 1304 may, by way of example and not limitation, use alpha testing by performing a texture lookup and deciding based on the texel's value whether or not to discard an intersection.

Once TraceRay( ) has completed the search for ray-scene intersections, either a miss shader 1308 or a closest hit shader 1310 may be invoked, depending on the outcome of the search. The closest hit shader 1310 may perform most shading operations, such as, material evaluation, texture lookups, and so on. The miss shader 1308 may be used to implement environment lookups, for example. In at least one embodiment, one or more of the closest hit shader 1310 or the miss shader 1308 may recursively trace rays by calling TraceRay( ) themselves.

The ray tracing pipeline 1300 constructed from any of the various shaders described herein may define a single-ray programming model. In at least one embodiment, each thread of the PPU 1000, and/or other PPU used to implement the ray tracing pipeline 1300, may handle one ray at a time. In at least one embodiment, each thread cannot communicate with other threads or see other rays currently being processed. This may simplify shader code, while allowing for vendor-specific optimizations using the API.

In at least one embodiment, different shaders and/or shader types may communicate with each other using a ray payload. A ray payload may refer to a user-defined struct that's passed as an INOUT parameter to TraceRay( ). For example, an any hit shader 1304, a closest hit shader 1310, and/or a miss shader 1308 may read from and/or write to the ray payload, and therefore pass back the result of their computations to the caller of TraceRay( ).

In at least one embodiment, a ray generation shader 1302 may trace primary rays, which may include rays being sent into the scene originating from a virtual camera. However, ray generation shaders 1302 are not limited to this functionality. In at least one embodiment, a ray generation shader 1302 may base ray generation on rasterized g-buffer data (e.g., to trace reflections). Using this approach, ray tracing may be used to complement rasterization, rather than replace rasterization.

When using traditional rasterization, only the shaders required by the current object being drawn may have to be active on the PPU. This may allow rasterization pipeline objects to be relatively small, containing a single set of vertex shaders, pixel shaders, etc. In contrast, a ray tracing pipeline 1300 may be used to arbitrarily shoot rays into the scene. This may mean the rays could hit any object or many objects in the scene. Therefore, it may be the case that all shaders for all objects could potentially be hit and therefore it may be desirable for the shaders to all be resident on the PPU and ready for execution.

In at least one embodiment, a state object may be used to group shaders together for execution. At a high level, a state object of a ray tracing pipeline 1300 may be seen as a binary executable resulting from a link step across all the shaders compiled for the scene. The relationship between different shaders may be specified at state object creation. For example, triplets of intersection shaders 1306, any hit shaders 1304, and/or closest hit shaders 1310 may be bundled into hit groups. The application may specify the state object of the ray tracing pipeline 1300 to be executed when calling a DispatchRays( ) function on a command list. A DispathRays( ) function may invoke a ray generation shader 1302 for each pixel for an image. In at least one embodiment, an application may create any number of state objects for a ray tracing pipeline 1300 and may re-use precompiled shaders for this purpose.

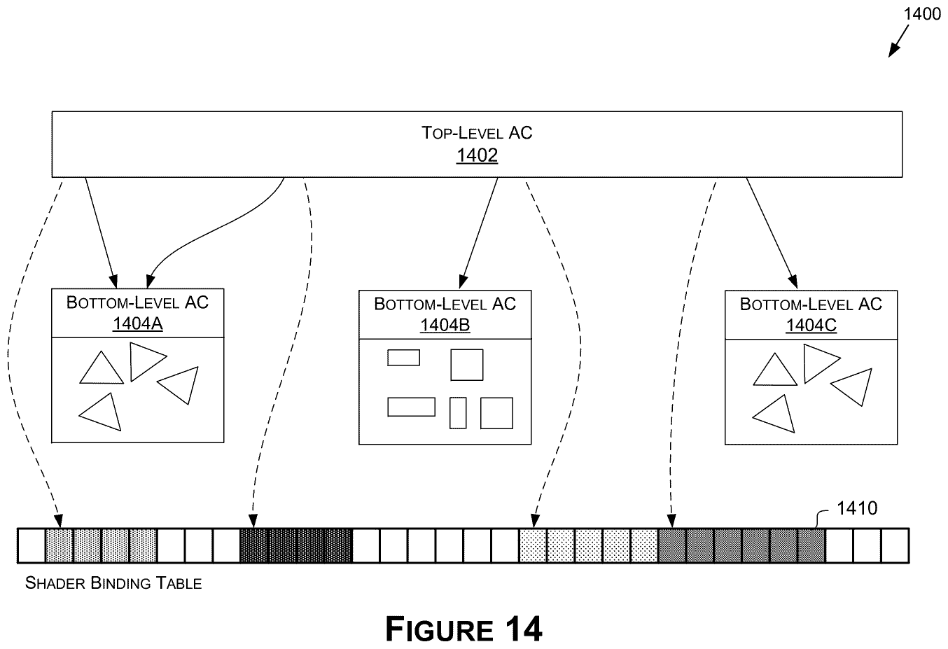

Referring now to FIG. 14, FIG. 14 illustrates an example acceleration structure 1400 suitable for use in implementing at least some embodiments of the present disclosure. The acceleration structure 1400 includes one or more top-level acceleration structures, such as a top-level acceleration structure 1402, and one or more bottom-level acceleration structures, such as bottom-level acceleration structures 1404A, 1404B, and 1404C.

The acceleration structure 1400 may comprise a spatial search data structure used in a ray tracing pipeline 1300 for acceleration structure traversal 1320 to efficiently compute intersections of rays with scene geometry. In at least one embodiment, the application may build an acceleration structure 1400 explicitly using a command list method BuildRaytracingAccelerationStructure( ). In at least one embodiment, the application may optimize an acceleration structure 1400 for different types of content, such as static versus animated content.

A top-level acceleration structure 1402 may be built from one or more references to one or more bottom-level acceleration structures 1404A, 1404B, and/or 1404C. These references may be referred to as instance descriptors. Each instance descriptor may include a transformation matrix to position the instance descriptor in the scene, and an offset into a shader table 1410 (which may also be referred to as a “shader binding table”) to locate material information. In at least one embodiment, a top-level acceleration structure 1402 may be used as a scene parameter provided to TraceRay( ) in a ray generation shader 1302, and may represent an entry point of the intersection search.

A ray tracing pipeline 1300 may specify the shaders that exist in a scene and an acceleration structure 1400 may specify geometry for the scene. The shader table 1410 may refer to a data structure used to tie the geometry to the shaders. For example, the shader table 1410 may define which shader is associated with which object in the scene. In addition, the shader table 1410 may hold information about the resources accessed by each shader, such as textures, buffers, and constants.

A shader table 1410 may comprise a chunk of PPU memory, which may be managed by the application. The application may be responsible for allocating the resource, filling the shader table 1410 with valid data, transferring it to the PPU, and correctly synchronizing the shader table 1410 with ray tracing dispatches. The application may also maintain multiple shader tables 1410, and, for example, multi-buffer them to update one copy while using another for rendering.

A shader table 1410 may comprise an array of equal-sized shader records. Each shader record may associate a shader (or a hit group) with a set of resources. In at least one embodiment, there may exist one record per geometry object in the scene, and a shader table 1410 may include thousands of entries or more.

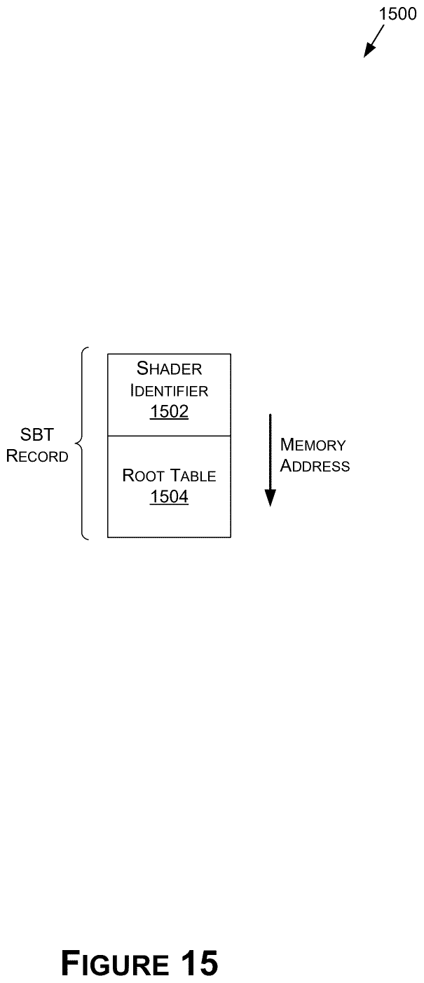

Referring now to FIG. 15, FIG. 15 illustrates an example shader record 1500 suitable for use in implementing at least some embodiments of the present disclosure. The shader record 1500 is an example of a shader record that may be included in the shader table 1410 of FIG. 14. The shader record 1500 includes a shader identifier 1502 and a root table 1504.

In at least one embodiment, the shader identifier 1502 may be represented in a beginning portion of the shader record 1500 in memory. The shader identifier 1502 may be an opaque identifier, which the application obtains by querying for the shader identifier 1502 from a compiled shader. The root table 1504 may contain the shader's resources. The layout of the root table 1504 may be defined by the shader's local root signature. The root signature may contain any combination of constants, descriptor tables, and root descriptors. For ray tracing, the application may directly access the root table 1504 in memory (e.g., rather than using “setter” methods), which may allow for efficient updates. In at least one embodiment, a shader table 1410 may be updated from a PPU shader.

As described herein, shader table offsets may be used when building a top-level acceleration structure 1402 from instance descriptors. The system may use these offsets to locate the correct shader record 1500 whenever TraceRay( ) finds an intersection. The system may then bind the resources defined in the shader record 1500 and execute the appropriate shader for the intersected geometry.

### EXAMPLE COMPUTING DEVICE

FIG. 16 is a block diagram of an example computing device(s) 1600 suitable for use in implementing at least some embodiments of the present disclosure. Computing device 1600 may include an interconnect system 1602 that directly or indirectly couples the following devices: memory 1604, one or more central processing units (CPUs) 1606, one or more graphics processing units (GPUs) 1608, a communication interface 1610, input/output (I/O) ports 1612, input/output components 1614, a power supply 1616, one or more presentation components 1618 (e.g., display(s)), and one or more logic units 1620. In at least one embodiment, the computing device(s) 1600 may comprise one or more virtual machines (VMs), and/or any of the components thereof may comprise virtual components (e.g., virtual hardware components). For non-limiting examples, one or more of the GPUs 1608 may comprise one or more pups, one or more of the CPUs 1606 may comprise one or more vCPUs, and/or one or more of the logic units 1620 may comprise one or more virtual logic units. As such, a computing device(s) 1600 may include discrete components (e.g., a full GPU dedicated to the computing device 1600), virtual components (e.g., a portion of a GPU dedicated to the computing device 1600), or a combination thereof.

Although the various blocks of FIG. 16 are shown as connected via the interconnect system 1602 with lines, this is not intended to be limiting and is for clarity only. For example, in some embodiments, a presentation component 1618, such as a display device, may be considered an I/O component 1614 (e.g., if the display is a touch screen). As another example, the CPUs 1606 and/or GPUs 1608 may include memory (e.g., the memory 1604 may be representative of a storage device in addition to the memory of the GPUs 1608, the CPUs 1606, and/or other components). In other words, the computing device of FIG. 16 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 16.

The interconnect system 1602 may represent one or more links or busses, such as an address bus, a data bus, a control bus, or a combination thereof. The interconnect system 1602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1606 may be directly connected to the memory 1604. Further, the CPU 1606 may be directly connected to the GPU 1608. Where there is direct, or point-to-point connection between components, the interconnect system 1602 may include a PCIe link to carry out the connection. In these examples, a PCI bus need not be included in the computing device 1600.

The memory 1604 may include any of a variety of computer-readable media. The computer-readable media may be any available media that may be accessed by the computing device 1600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1606 may be configured to execute at least some of the computer-readable instructions to control one or more components of the computing device 1600 to perform one or more of the methods and/or processes described herein. The CPU(s) 1606 may each include one or more cores (e.g., one, two, four, eight, twenty-eight, seventy-two, etc.) that are capable of handling a multitude of software threads simultaneously. The CPU(s) 1606 may include any type of processor, and may include different types of processors depending on the type of computing device 1600 implemented (e.g., processors with fewer cores for mobile devices and processors with more cores for servers). For example, depending on the type of computing device 1600, the processor may be an Advanced RISC Machines (ARM) processor implemented using Reduced Instruction Set Computing (RISC) or an x86 processor implemented using Complex Instruction Set Computing (CISC). The computing device 1600 may include one or more CPUs 1606 in addition to one or more microprocessors or supplementary co-processors, such as math co-processors.

In addition to or alternatively from the CPU(s) 1606, the GPU(s) 1608 may be configured to execute at least some of the computer-readable instructions to control one or more components of the computing device 1600 to perform one or more of the methods and/or processes described herein. One or more of the GPU(s) 1608 may be an integrated GPU (e.g., with one or more of the CPU(s) 1606 and/or one or more of the GPU(s) 1608 may be a discrete GPU. In embodiments, one or more of the GPU(s) 1608 may be a coprocessor of one or more of the CPU(s) 1606. The GPU(s) 1608 may be used by the computing device 1600 to render graphics (e.g., 3D graphics) or perform general purpose computations. For example, the GPU(s) 1608 may be used for General-Purpose computing on GPUs (GPGPU). The GPU(s) 1608 may include hundreds or thousands of cores that are capable of handling hundreds or thousands of software threads simultaneously. The GPU(s) 1608 may generate pixel data for output images in response to rendering commands (e.g., rendering commands from the CPU(s) 1606 received via a host interface). The GPU(s) 1608 may include graphics memory, such as display memory, for storing pixel data or any other suitable data, such as GPGPU data. The display memory may be included as part of the memory 1604. The GPU(s) 1608 may include two or more GPUs operating in parallel (e.g., via a link). The link may directly connect the GPUs (e.g., using NVLINK) or may connect the GPUs through a switch (e.g., using NVSwitch). When combined together, each GPU 1608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1606 and/or the GPU(s) 1608, the logic unit(s) 1620 may be configured to execute at least some of the computer-readable instructions to control one or more components of the computing device 1600 to perform one or more of the methods and/or processes described herein. In embodiments, the CPU(s) 1606, the GPU(s) 1608, and/or the logic unit(s) 1620 may discretely or jointly perform any combination of the methods, processes and/or portions thereof. One or more of the logic units 1620 may be part of and/or integrated in one or more of the CPU(s) 1606 and/or the GPU(s) 1608 and/or one or more of the logic units 1620 may be discrete components or otherwise external to the CPU(s) 1606 and/or the GPU(s) 1608. In embodiments, one or more of the logic units 1620 may be a coprocessor of one or more of the CPU(s) 1606 and/or one or more of the GPU(s) 1608.

Examples of the logic unit(s) 1620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1610 may include one or more receivers, transmitters, and/or transceivers that enable the computing device 1600 to communicate with other computing devices via an electronic communication network, included wired and/or wireless communications. The communication interface 1610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1620 and/or communication interface 1610 may include one or more data processing units (DPUs) to transmit data received over a network and/or through interconnect system 1602 directly to (e.g., a memory of) one or more GPU(s) 1608.

The I/O ports 1612 may enable the computing device 1600 to be logically coupled to other devices including the I/O components 1614, the presentation component(s) 1618, and/or other components, some of which may be built in to (e.g., integrated in) the computing device 1600. Illustrative I/O components 1614 include a microphone, mouse, keyboard, joystick, game pad, game controller, satellite dish, scanner, printer, wireless device, etc. The I/O components 1614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1600. The computing device 1600 may be include depth cameras, such as stereoscopic camera systems, infrared camera systems, RGB camera systems, touchscreen technology, and combinations of these, for gesture detection and recognition. Additionally, the computing device 1600 may include accelerometers or gyroscopes (e.g., as part of an inertia measurement unit (IMU)) that enable detection of motion. In some examples, the output of the accelerometers or gyroscopes may be used by the computing device 1600 to render immersive augmented reality or virtual reality.

The power supply 1616 may include a hard-wired power supply, a battery power supply, or a combination thereof. The power supply 1616 may provide power to the computing device 1600 to enable the components of the computing device 1600 to operate.

The presentation component(s) 1618 may include a display (e.g., a monitor, a touch screen, a television screen, a heads-up-display (HUD), other display types, or a combination thereof), speakers, and/or other presentation components. The presentation component(s) 1618 may receive data from other components (e.g., the GPU(s) 1608, the CPU(s) 1606, DPUs, etc.), and output the data (e.g., as an image, video, sound, etc.).

### EXAMPLE DATA CENTER

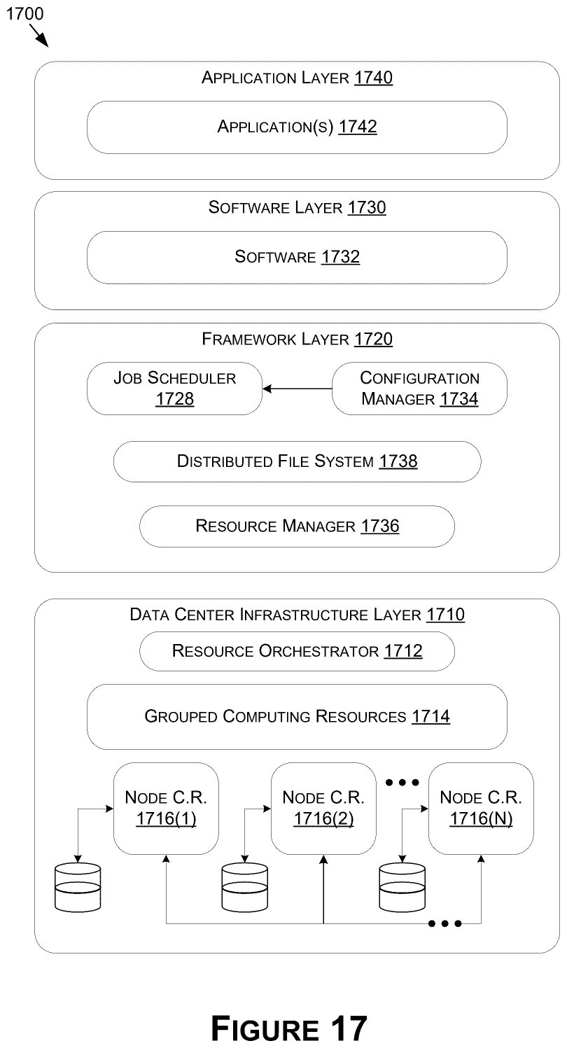

FIG. 17 illustrates an example data center 1700 that may be used in at least one embodiments of the present disclosure. The data center 1700 may include a data center infrastructure layer 1710, a framework layer 1720, a software layer 1730, and/or an application layer 1740.

As shown in FIG. 17, the data center infrastructure layer 1710 may include a resource orchestrator 1712, grouped computing resources 1714, and node computing resources (“node C.R.s”) 1716(1)-1716(N), where “N” represents any whole, positive integer. In at least one embodiment, node C.R.s 1716(1)-1716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1716(1)-1716(N) may correspond to a server having one or more of the above-mentioned computing resources. In addition, in some embodiments, the node C.R.s 1716(1)-17161(N) may include one or more virtual components, such as vGPUs, vCPUs, and/or the like, and/or one or more of the node C.R.s 1716(1)-1716(N) may correspond to a virtual machine (VM).

In at least one embodiment, grouped computing resources 1714 may include separate groupings of node C.R.s 1716 housed within one or more racks (not shown), or many racks housed in data centers at various geographical locations (also not shown). Separate groupings of node C.R.s 1716 within grouped computing resources 1714 may include grouped compute, network, memory or storage resources that may be configured or allocated to support one or more workloads. In at least one embodiment, several node C.R.s 1716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1712 may configure or otherwise control one or more node C.R.s 1716(1)-1716(N) and/or grouped computing resources 1714. In at least one embodiment, resource orchestrator 1712 may include a software design infrastructure (SDI) management entity for the data center 1700. The resource orchestrator 1712 may include hardware, software, or some combination thereof.

In at least one embodiment, as shown in FIG. 17, framework layer 1720 may include a job scheduler 1728, a configuration manager 1734, a resource manager 1736, and/or a distributed file system 1738. The framework layer 1720 may include a framework to support software 1732 of software layer 1730 and/or one or more application(s) 1742 of application layer 1740. The software 1732 or application(s) 1742 may respectively include web-based service software or applications, such as those provided by Amazon Web Services, Google Cloud and Microsoft Azure. The framework layer 1720 may be, but is not limited to, a type of free and open-source software web application framework such as Apache Spark™ (hereinafter “Spark”) that may utilize distributed file system 1738 for large-scale data processing (e.g., “big data”). In at least one embodiment, job scheduler 1728 may include a Spark driver to facilitate scheduling of workloads supported by various layers of data center 1700. The configuration manager 1734 may be capable of configuring different layers such as software layer 1730 and framework layer 1720 including Spark and distributed file system 1738 for supporting large-scale data processing. The resource manager 1736 may be capable of managing clustered or grouped computing resources mapped to or allocated for support of distributed file system 1738 and job scheduler 1728. In at least one embodiment, clustered or grouped computing resources may include grouped computing resource 1714 at data center infrastructure layer 1710. The resource manager 1736 may coordinate with resource orchestrator 1712 to manage these mapped or allocated computing resources.

In at least one embodiment, software 1732 included in software layer 1730 may include software used by at least portions of node C.R.s 1716(1)-1716(N), grouped computing resources 1714, and/or distributed file system 1738 of framework layer 1720. One or more types of software may include, but are not limited to, Internet web page search software, e-mail virus scan software, database software, and streaming video content software.

In at least one embodiment, application(s) 1742 included in application layer 1740 may include one or more types of applications used by at least portions of node C.R.s 1716(1)-1716(N), grouped computing resources 1714, and/or distributed file system 1738 of framework layer 1720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1734, resource manager 1736, and resource orchestrator 1712 may implement any number and type of self-modifying actions based on any amount and type of data acquired in any technically feasible fashion. Self-modifying actions may relieve a data center operator of data center 1700 from making possibly bad configuration decisions and possibly avoiding underused and/or poor performing portions of a data center.

The data center 1700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1700. In at least one embodiment, trained or deployed machine learning models corresponding to one or more neural networks may be used to infer or predict information using resources described above with respect to the data center 1700 by using weight parameters calculated through one or more training techniques, such as but not limited to those described herein.

In at least one embodiment, the data center 1700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1600 of FIG. 16—e.g., each device may include similar components, features, and/or functionality of the computing device(s) 1600. In addition, where backend devices (e.g., servers, NAS, etc.) are implemented, the backend devices may be included as part of a data center 1700, an example of which is described in more detail herein with respect to FIG. 17.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1600 described herein with respect to FIG. 16. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A. A method comprising: determining, based at least on information corresponding to one or more resources associated with a first instance of an application running on one or more servers, one or more classifications associated with the one or more resources; allocating, based at least on the one or more classifications, one or more regions of a virtual memory for binding to the one or more resources; mapping the one or more regions of the virtual memory to one or more first regions of a physical memory allocated for storing the one or more resources; determining that at least one resource of the one or more resources is a duplicative resource of at least a second resource associated with one or more second instances of the application running on the one or more servers; and based at least on the at least one resource being the duplicative resource, remapping the one or more regions of the virtual memory to one or more second regions of the physical memory allocated for storing the at least the second resource.
B. The method as recited in any one of paragraphs 1, further comprising causing a release of one or more first regions of the physical memory based at least on the remapping of the one or more regions of the virtual memory to the one or more second regions of the physical memory.
C. The method as recited in any one of paragraphs 1, further comprising processing, using the one or more regions of the virtual memory mapped to the one or more second regions of the physical memory, a request to access the at least one resource in association with the first instance of the application.
D. The method as recited in any one of paragraphs 1, wherein the determining of the one or more classifications associated with the one or more resources is based at least on evaluating one or more properties included in the information, the information associated with the first instance of the application requesting generation of the one or more resources.
E. The method as recited in any one of paragraphs 1, wherein at least one classification of the one or more classifications is associated with at least one resource of the one or more resources, the at least one classification indicating that the at least one resource is a static resource capable of being shared between different instances of the application, and wherein the allocating of the one or more regions of the virtual memory is based at least on the at least one resource being the static resource.
F. The method as recited in any one of paragraphs 1, further comprising allocating one or more third regions of the physical memory for storing the one or more resources associated with the first instance of the application, the one or more third regions of the physical memory including the one or more regions of the physical memory, the one or more resources including at least one or more shareable resources and one or more non-shareable resources, wherein the mapping is based at least on the allocating of the one or more third regions of the physical memory.
G. The method as recited in any one of paragraphs 1, further comprising: allocating one or more second regions of the virtual memory for binding to at least a subset of the one or more resources; mapping the one or more second regions of the virtual memory to one or more third regions of the physical memory; determining that at least the subset of the one or more resources includes one or more original resources associated with the application running on the one or more servers; and storing, in one or more databases, data indicating that at least the subset of the one or more resources is stored using the one or more third regions of the physical memory.
H. A system comprising: one or more processors to: compute one or more identifiers for one or more first resources associated with one or more first application instances; determine, based at least on querying one or more data sources using the one or more identifiers, that one or more first portions of at least one memory have been allocated for storing one or more second resources that are duplicative of the one or more first resources, the one or more second resources associated with one or more second application instances; and based at least on the determination, release one or more second portions of the at least one memory allocated for storing the one or more first resources.
I. The system as recited in any one of paragraphs 8, wherein the one or more processors further to determine, based at least on evaluating one or more properties included in metadata associated with the one or more first resources, one or more classifications corresponding to the one or more first resources associated with the one or more first application instances, the one or more classifications indicating that the one or more first resources are capable of being shared between application instances running on one or more servers.
J. The system as recited in any one of paragraphs 9, wherein the one or more classifications indicate that the one or more first resources are static resources, the static resources including at least one of: texture resources associated with the one or more first application instances; mesh data associated with the one or more first application instances; or shader code associated with the one or more first application instances.
K. The system as recited in any one of paragraphs 8, wherein the one or more processors further to: allocate one or more portions of a virtual memory for the one or more first application instances; and map the one or more portions of the virtual memory to the one or more second portions of the at least one memory, wherein the at least one memory is a physical memory.
L. The system as recited in any one of paragraphs 11, wherein the one or more processors further to update, based at least on the determination, a mapping of the one or more portions of the virtual memory from being mapped to the one or more second portions of the at least one memory to being mapped to the one or more first portions of the at least one memory.
M. The system as recited in any one of paragraphs 12, wherein the one or more processors further to process, using the one or more portions of the virtual memory mapped to the one or more first portions of the at least one memory, a request to access the one or more first resources in association with the one or more first application instances.
N. The system as recited in any one of paragraphs 8, wherein the one or more processors further to: query the one or more data sources using the one or more identifiers; and determine, based at least on the query, a presence of one or more second identifiers in the one or more data sources, the one or more second identifiers being duplicative of the one or more identifiers; wherein the determination that the one or more first portions of the at least one memory have been allocated for storing the one or more second resources is based at least on the one or more data sources including the one or more second identifiers.
O. The system as recited in any one of paragraphs 8, wherein the computation of the one or more identifiers for the one or more first resources comprises computing, using one or more graphics processing units (GPUs), one or more hash values for the one or more first resources.
P. The system as recited in any one of paragraphs 8, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
Q. At least one processor comprising: processing circuitry to update a mapping between an allocation of a virtual memory for a resource and a first portion of a physical memory allocated for storing the resource such that the allocation of the virtual memory is mapped to a second portion of the physical memory allocated for storing a duplicate resource of the resource, and to release the first portion of the physical memory based at least on the update of the mapping.
R. The at least one processor as recited in any one of paragraphs 17, the processing circuitry further to determine, based at least on querying a database using an identifier computed for the resource, that the second portion of the physical memory has been allocated for storing the duplicate resource, wherein the mapping is updated based at least on the determination.
S. The at least one processor as recited in any one of paragraphs 17, the processing circuitry further to determine a classification associated with the resource based at least on evaluating one or more properties included in metadata associated with the resource, wherein the allocation of the of the virtual memory for the resource is based at least on the classification associated with the resource indicating that the resource is capable of being shared between instances of one or more applications.
T. The processor as recited in any one of paragraphs 17, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
determining, based at least on information corresponding to one or more resources associated with a first instance of an application running on one or more servers, one or more classifications associated with the one or more resources;
allocating, based at least on the one or more classifications, one or more regions of a virtual memory for binding to the one or more resources;
mapping the one or more regions of the virtual memory to one or more first regions of a physical memory allocated for storing the one or more resources;
determining that at least one resource of the one or more resources is a duplicative resource of at least a second resource associated with one or more second instances of the application running on the one or more servers; and
based at least on the at least one resource being the duplicative resource, remapping the one or more regions of the virtual memory to one or more second regions of the physical memory allocated for storing the at least the second resource.

2. The method of claim 1, further comprising causing a release of one or more first regions of the physical memory based at least on the remapping of the one or more regions of the virtual memory to the one or more second regions of the physical memory.

3. The method of claim 1, further comprising processing, using the one or more regions of the virtual memory mapped to the one or more second regions of the physical memory, a request to access the at least one resource in association with the first instance of the application.

4. The method of claim 1, wherein the determining of the one or more classifications associated with the one or more resources is based at least on evaluating one or more properties included in the information, the information associated with the first instance of the application requesting generation of the one or more resources.

5. The method of claim 1, wherein at least one classification of the one or more classifications is associated with at least one resource of the one or more resources, the at least one classification indicating that the at least one resource is a static resource capable of being shared between different instances of the application, and wherein the allocating of the one or more regions of the virtual memory is based at least on the at least one resource being the static resource.

6. The method of claim 1, further comprising allocating one or more third regions of the physical memory for storing the one or more resources associated with the first instance of the application, the one or more third regions of the physical memory including the one or more regions of the physical memory, the one or more resources including at least one or more shareable resources and one or more non-shareable resources, wherein the mapping is based at least on the allocating of the one or more third regions of the physical memory.

7. The method of claim 1, further comprising:
allocating one or more second regions of the virtual memory for binding to at least a subset of the one or more resources;
mapping the one or more second regions of the virtual memory to one or more third regions of the physical memory;
determining that at least the subset of the one or more resources includes one or more original resources associated with the application running on the one or more servers; and
storing, in one or more databases, data indicating that at least the subset of the one or more resources is stored using the one or more third regions of the physical memory.

8. A system comprising:
one or more processors to:
compute one or more identifiers for one or more first resources associated with one or more first application instances;
determine, based at least on querying one or more data sources using the one or more identifiers, that one or more first portions of at least one memory have been allocated for storing one or more second resources that are duplicative of the one or more first resources, the one or more second resources associated with one or more second application instances; and
based at least on the determination, release one or more second portions of the at least one memory allocated for storing the one or more first resources.

9. The system of claim 8, wherein the one or more processors further to determine, based at least on evaluating one or more properties included in metadata associated with the one or more first resources, one or more classifications corresponding to the one or more first resources associated with the one or more first application instances, the one or more classifications indicating that the one or more first resources are capable of being shared between application instances running on one or more servers.

10. The system of claim 9, wherein the one or more classifications indicate that the one or more first resources are static resources, the static resources including at least one of:
texture resources associated with the one or more first application instances;
mesh data associated with the one or more first application instances; or
shader code associated with the one or more first application instances.

11. The system of claim 8, wherein the one or more processors further to:
allocate one or more portions of a virtual memory for the one or more first application instances; and
map the one or more portions of the virtual memory to the one or more second portions of the at least one memory, wherein the at least one memory is a physical memory.

12. The system of claim 11, wherein the one or more processors further to update, based at least on the determination, a mapping of the one or more portions of the virtual memory from being mapped to the one or more second portions of the at least one memory to being mapped to the one or more first portions of the at least one memory.

13. The system of claim 12, wherein the one or more processors further to process, using the one or more portions of the virtual memory mapped to the one or more first portions of the at least one memory, a request to access the one or more first resources in association with the one or more first application instances.

14. The system of claim 8, wherein the one or more processors further to:
query the one or more data sources using the one or more identifiers; and
determine, based at least on the query, a presence of one or more second identifiers in the one or more data sources, the one or more second identifiers being duplicative of the one or more identifiers;
wherein the determination that the one or more first portions of the at least one memory have been allocated for storing the one or more second resources is based at least on the one or more data sources including the one or more second identifiers.

15. The system of claim 8, wherein the computation of the one or more identifiers for the one or more first resources comprises computing, using one or more graphics processing units (GPUs), one or more hash values for the one or more first resources.

16. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

17. At least one processor comprising:
processing circuitry to update a mapping between an allocation of a virtual memory for a resource and a first portion of a physical memory allocated for storing the resource such that the allocation of the virtual memory is mapped to a second portion of the physical memory allocated for storing a duplicate resource of the resource, and to release the first portion of the physical memory based at least on the update of the mapping.

18. The at least one processor of claim 17, the processing circuitry further to determine, based at least on querying a database using an identifier computed for the resource, that the second portion of the physical memory has been allocated for storing the duplicate resource, wherein the mapping is updated based at least on the determination.

19. The at least one processor of claim 17, the processing circuitry further to determine a classification associated with the resource based at least on evaluating one or more properties included in metadata associated with the resource, wherein the allocation of the of the virtual memory for the resource is based at least on the classification associated with the resource indicating that the resource is capable of being shared between instances of one or more applications.

20. The processor of claim 17, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
